(19) United States
(12) Patent Application Publication
(10) Pub. No.: US 2012/0231963 A1
(43) Pub. Date: Sep. 13, 2012

(54) BIOTIN-LABEL-BASED ANTIBODY ARRAY FOR HIGH-CONTENT PROFILING OF PROTEIN EXPRESSION

(75) Inventors: Ruo-Chun Huang, Duluth, GA (US); Ruo Pan Huang, Johns Creek, GA (US)

(73) Assignee: RAYBIOTECH, INC,, Norcross, GA (US)

(21) Appl. No.: 13/044,791

(22) Filed: Mar. 10, 2011

(51) Int. Cl. C40B 30/04; C40B 40/10

(52) U.S. Cl. 506/9; 506/18

(57) ABSTRACT

The biotin-label-based array methods of the present disclosure have several advantages over fluorescence label. Biotin-label can be used as signal amplification. Biotin is the most common method for labeling protein and the label process can be highly efficient. Furthermore, biotin can be detected using fluorescence-streptavidin and, therefore, visualized using laser scanner, or by using HRP-streptavidin imaged using chemiluminescence. The results of the present disclosure show that using biotin-label-based antibody arrays, most targeted proteins can be detected at pg/ml levels. Systems for identifying at least one biomarker characteristic of a cancer or a cancer cell comprise: an antibody array comprising at least one antibody species capable of capturing a biomarker characteristic of a cancer or a cancer cell; a system for biotinylating at least one biomarker of a biosample obtained from a subject human or animal; and a detectable biotin-binding polypeptide.

### TECHNICAL FIELD

The present disclosure is generally related to methods of detecting cancer markers by a biotin-label based high-throughput antibody array system.

### BACKGROUND

Antibody microarrays have emerged as a promising technology for multiplexed, quantitative, fast and cost-effective protein expression profiling, functional determination and biomarker discovery, using a tiny amount of sample (Huang R. P. (2007) Expert Rev. Proteomics 4: 299-308; Huang et al., (2005) Expert Opin. Ther. Targets 9: 601-615). Among different approaches of protein detection using antibody arrays, sandwich-based antibody arrays are the most common. Hundreds of publications have documented the suitability of sandwich-based antibody arrays to detect differential protein expression patterns using various sample types, including serum (Hashimoto et al., (2006) Obesity 14: 799-811), plasma (Ray et al., (2007) Nat. Med. 13: 1359-1362), cell-cultured media (Turtinen et al., (2004) Antimicrob. Agents Chemother. 48: 396-403; De et al., (2004) Biochem. Biophys. Res. Commun. 323: 960-969), cell co-cultures (Sell et al., (2006) Endocrinology 147: 2458-2467), cell and tissue lysates (Haddad & Belosevic (2009) Mol. Immunol. 46: 576-586; Vargas et al., (2005) Ann. Neurol. 57: 67-81), cerebrospinal fluid (Vargas et al., (2005) Ann. Neurol. 57: 67-81), urine (Liu et al., (2006) Am. J. Nephrol. 26: 483-490) abscess fluid (Fu et al., (2007) Can. J. Ophthalmol. 42: 865-869), platelet releasates (Coppinger et al., (2007) Blood 109: 4786-4792), bronchoalveolar lavage (Simcock et al., (2007) Am. J. Respir. Crit. Care Med. 176: 146-153), sputum (Kim et al., (2009) Chest 135: 295-302), breath condensates (Matsunaga et al., (2006) J. Allergy Clin. Immunol. 118: 84-90), saliva (De et al., (2004) Biochem. Biophys. Res. Commun. 323: 960-969), tears (Sack et al., (2005) Invest. Ophthalmol. Vis. Sci. 46: 1228-1238), prostatic fluid (Kverka et al., (2007) Clin. Chem. 53: 955-962), and milk and colostrum (Fujita et al., (2008) Prostate 68: 872-882).

Sandwich-based arrays use the same method of detection as a standard ELISA, meaning that these multiplex arrays feature high detection sensitivity, specificity, reproducibility and the potential for quantitative measurement. However, the requirement of a pair of antibodies to detect each protein (analyte) hampers the development of higher density antibody arrays. Because antibodies can have unintended interactions with other antibodies, the higher the number of antibody pairs in the array, the greater the amount of development work needed to eliminate false signals in the multiplexed array. However, in most of biomedical research and biomarker discovery program, high density antibody arrays are more desirable, since they can reveal much more information and provide a more global view of protein expression patterns. Therefore, great efforts have been expended to develop higher density antibody arrays. One way to overcome this obstacle is to directly label samples with fluorescent dyes such as Cy3 and Cy5. The labeled samples are then applied on the antibody array chip. The bound proteins are then visualized by laser scanner. Since only capture antibodies are required, this approach can be used to detect hundreds of target proteins simultaneously. The main problem for this approach includes low detection sensitivity, a complicated procedure, and the limitation of comparison of two samples. This approach also suffers from limited sample compatibility and the requirement of a laser scanner for detection. The development of a biotin-label-based antibody arrays (Lin et al., (2003) Proteomics 3: 1750-1757). In this report, we further improve the technology and demonstrate the reliability of this approach. In addition, the technology is used to screen and identify potential cancer biomarkers.

### SUMMARY

Briefly described, embodiments of this disclosure, among others, encompass systems for identifying at least one biomarker characteristic of a cancer or a cancer cell, the system comprising: (a) an antibody array comprising at least one antibody species capable of capturing a biomarker characteristic of a cancer or a cancer cell; (b) a system for biotinylating at least one biomarker of a biosample obtained from a subject human or animal; and (c) a detectable biotin-binding polypeptide.

In embodiments of this aspect of the disclosure, the system can further comprise a system to detect the biotin-binding polypeptide.

In embodiments of this aspect of the disclosure, the system can further comprise a system for solubilizing the at least one biomarker of a biosample obtained from a subject human or animal.

In some embodiments of this aspect of the disclosure, the system can further comprise a system for solubilizing the at least one biomarker of a biosample obtained from a subject human or animal comprises a system for lysing cells of the biosample.

In the embodiments of this aspect of the disclosure, the biomarker, or a plurality of said biomarkers, can be selected from the group consisting of: activin A; IL-18 BPa, adiponectin/acrp30, IL-18 receptor α/IL-1 R5, AgRP, IL-18 receptor β/AcPL, ALCAM, IL-2 receptor α, angiogenin, IL-2 receptor α, AR (amphiregulin), IL-3, Axl, IL-4, B7-1/CD80, I-TAC/CXCL11, BCMA/TNFRSF17, leptin (OB), BDNF, LIF, β-NGF, LIGHT/TNFSF14, BLC/BCA-1/CXCL13, LIGHT/TNFSF14, BMP-5, MCP-2, BTC, MCP-3, cardiotrophin-1/CT-1, MCP-4/CCL13, CTLA-4/CD152, M-CSF, CXCL16, MMP-10, Dtk, MMP-13, EGF, MMP-9, EGF receptor/ErbB1, MSP α-chain, endoglin/CD105, MSP β-chain, Eotaxin/CCL11, NAP-2, eotaxin-2/MPIF-2, NGF R, eotaxin-3/CCL26, NT-4, ErbB3, OSM, Fas/TNFRSF6, osteoprotegerin, Fas Ligand, PDGF receptor β, FGF Basic, PDGF-AA, FGF-4, PDGF-AB, FGF-6, PDGF-BB, FGF-7/KGF, PIGF, FGF-9, P-selectin, follistatin, RAGE, GITR/TNFRF18, RANTES, HB-EGF, SCF, HCC-4/CCL16, SCF receptor/CD117, HGF, sgp130, I-309, Siglec-9, IGFBP-1, siglec-5/CD170, IGFBP-2, Tarc, IGFBP-3, TGFα, IGF-I, TNF RI/TNFRSF1A, IGF-I, TNF RII/TNFRSF1B, IGF-I S receptor, TNFβ, IGF-II, TRAIL R1/DR4/TNFRSF 10/, IGF-II, TRAIL R3/TNFRSF 10C, IL-1α, TRAIL R4/TNFRSF 10D, IL-1β, TRANCE, IL-1 R4/ST2, TREM-1, IL-1 sRI, TROP/TNFRSF19, IL-1 sRI, uPAR, IL-10, VCAM-1 (CD106), IL-10 receptor β, VE-cadherin, IL-13 receptor α1, VEGF, IL-13 receptor α2, VEGF R2 (KDR), IL-17, VEGF R3, or any combination thereof.

In embodiments of this aspect of the disclosure, the antibody array can comprise a plurality of antibody species capable of specifically capturing at least one biomarker characteristic of a cancer or a cell thereof, wherein the cancer is selected from the group consisting of: bladder cancer, breast cancer, colorectal cancer, endometrial cancer, head and neck cancer, leukemia, lung cancer, lymphoma, melanoma, non-small-cell lung cancer, ovarian cancer, prostate cancer, testicular cancer, uterine cancer, cervical cancer, thyroid cancer, gastric cancer, brain stem glioma, cerebellar astrocytoma, cerebral astrocytoma, glioblastoma, ependymoma, Ewing's sarcoma family of tumors, germ cell tumor, extracranial cancer, Hodgkin's disease, leukemia, acute lymphoblastic leukemia, acute myeloid leukemia, liver cancer, medulloblastoma, neuroblastoma, brain tumors generally, non-Hodgkin's lymphoma, osteosarcoma, malignant fibrous histiocytoma of bone, retinoblastoma, rhabdomyosarcoma, soft tissue sarcomas generally, supratentorial primitive neuroectodermal and pineal tumors, visual pathway and hypothalamic glioma, Wilms' tumor, acute lymphocytic leukemia, adult acute myeloid leukemia, adult non-Hodgkin's lymphoma, chronic lymphocytic leukemia, chronic myeloid leukemia, esophageal cancer, hairy cell leukemia, kidney cancer, multiple myeloma, oral cancer, pancreatic cancer, primary central nervous system lymphoma, skin cancer, and small-cell lung cancer.

In embodiments of this aspect of the disclosure, the antibody array can comprise a plurality of antibody species capable of specifically capturing at least one biomarker characteristic of an ovarian cancer.

In embodiments of this aspect of the disclosure, the biotin-binding polypeptide can be avidin or streptavidin, or a biotin-binding variant thereof, and the biotin-binding polypeptide can be conjugated to a detectable labeling moiety.

In embodiments of this aspect of the disclosure, the detectable labeling moiety can be a dye, a fluorescent moiety, or an enzyme. In other embodiments of this aspect of the disclosure, the enzyme is a horse radish peroxidase. In yet other embodiments of this aspect of the disclosure, the detectable labeling moiety is a dye.

Another aspect of the disclosure encompasses embodiments of a method of detecting at least one biomarker characteristic of a cancer or a cancer cell, the method comprising: (a) obtaining a first biosample from a first subject human or animal; (b) biotinylating a constituent of the first biosample; (c) contacting the biotinylated first biosample to a first antibody array, said first antibody array comprising at least one antibody species capable of capturing a biomarker characteristic of a cancer or a cancer cell, under conditions whereby a biomarker can selectively bind to an antibody of the first antibody array; (d) contacting the first antibody array with a detectable biotin-binding polypeptide under conditions whereby the detectable biotin-binding polypeptide can selectively bind to a biotin moiety conjugated to a biomarker of the first biosample, wherein said biomarker is selectively bound to an antibody of the antibody array; and (e) detecting the detectable biotin-binding polypeptide bound to a biotin moiety conjugated to a biomarker of the biosample, wherein said biomarker is selectively bound to an antibody of the first antibody array.

In embodiments of the method of this aspect of the disclosure, the first biosample can be obtained from a subject human or animal having a cancer, and further comprising the steps of: (f) obtaining a second biosample from a second subject human or animal not having a cancer; (g) contacting the second biosample with a system for biotinylating a constituent of the second biosample; (h) contacting the biotinylated second biosample to a second antibody array, where the first and the second antibody arrays are identical, and under conditions whereby a biomarker can selectively bind to an antibody of the second antibody array; (i) contacting the second antibody array with a detectable biotin-binding polypeptide under conditions whereby the detectable biotin-binding polypeptide can selectively bind to a biotin moiety conjugated to a constituent of the second biosample, wherein said constituent is a biomarker selectively bound to an antibody of the second antibody array; (j) detecting the detectable biotin-binding polypeptide bound to a biotin moiety conjugated to a constituent of the second biosample, wherein said constituent is a biomarker selectively bound to an antibody of the second antibody array; and (k) comparing the results of steps (e) and (j), whereupon a detectable signal on the first antibody array but not on the second antibody array indicates the identity of a biomarker characteristic of the cancer of the first subject human or animal.

In embodiments of the method of this aspect of the disclosure, the detectable biotin-binding polypeptide can be an avidin, a streptavidin, or a biotin-binding variant thereof, and wherein the detectable biotin-binding polypeptide can be conjugated to a detectable labeling moiety.

In embodiments of the method of this aspect of the disclosure, the biomarker, or a plurality of said biomarkers, can be selected from the group consisting of: activin A; IL-18 BPa, adiponectin/acrp30, IL-18 receptor alpha/IL-1 R5, AgRP, IL-18 receptor 13/AcPL, ALCAM, IL-2 receptor α, angiogenin, IL-2 receptor α, AR (amphiregulin), IL-3, Axl, IL-4, B7-1/CD80, I-TAC/CXCL11, BCMA/TNFRSF17, leptin (OB), BDNF, LIF, β-NGF, LIGHT/TNFSF14, BLC/BCA-1/CXCL13, LIGHT/TNFSF14, BMP-5, MCP-2, BTC, MCP-3, cardiotrophin-1/CT-1, MCP-4/CCL13, CTLA-4/CD152, M-CSF, CXCL16, MMP-10, Dtk, MMP-13, EGF, MMP-9, EGF receptor/ErbB1, MSP a Chain, endoglin/CD105, MSP β-chain, Eotaxin/CCL11, NAP-2, eotaxin-2/MPIF-2, NGF R, eotaxin-3/CCL26, NT-4, ErbB3, OSM, Fas/TNFRSF6, osteoprotegerin, Fas Ligand, PDGF receptor β, FGF Basic, PDGF-AA, FGF-4, PDGF-AB, FGF-6, PDGF-BB, FGF-7/KGF, PIGF, FGF-9, P-selectin, follistatin, RAGE, GITR/TNFRF18, RANTES, HB-EGF, SCF, HCC-4/CCL16, SCF receptor/CD117, HGF, sgp130, I-309, Siglec-9, IGFBP-1, siglec-5/CD170, IGFBP-2, Tarc, IGFBP-3, TGFα, IGF-I, TNF RI/TNFRSF1A, IGF-I, TNF R11/TNFRSF1B, IGF-I S receptor, TNFβ, IGF-II, TRAIL R1/DR4/TNFRSF 10/, IGF-II, TRAIL R3/TNFRSF 10C, IL-1α, TRAIL R4/TNFRSF 10D, IL-1β, TRANCE, IL-1 R4/ST2, TREM-1, IL-1 sRI, TROP/TNFRSF19, IL-1 sRI, uPAR, IL-10, VCAM-1 (CD106), IL-10 receptor β, VE-cadherin, IL-13 receptor a 1, VEGF, IL-13 receptor a 2, VEGF R2 (KDR), IL-17, VEGF R3, or any combination thereof.

In embodiments of the method of this aspect of the disclosure, the antibody array comprises a plurality of antibody species capable of specifically capturing at least one biomarker characteristic of a cancer or a cell thereof, wherein the cancer can be selected from the group consisting of: bladder cancer, breast cancer, colorectal cancer, endometrial cancer, head and neck cancer, leukemia, lung cancer, lymphoma, melanoma, non-small-cell lung cancer, ovarian cancer, prostate cancer, testicular cancer, uterine cancer, cervical cancer, thyroid cancer, gastric cancer, brain stem glioma, cerebellar astrocytoma, cerebral astrocytoma, glioblastoma, ependymoma, Ewing's sarcoma family of tumors, germ cell tumor, extracranial cancer, Hodgkin's disease, leukemia, acute lymphoblastic leukemia, acute myeloid leukemia, liver cancer, medulloblastoma, neuroblastoma, brain tumors generally, non-Hodgkin's lymphoma, osteosarcoma, malignant fibrous histiocytoma of bone, retinoblastoma, rhabdomyosarcoma, soft tissue sarcomas generally, supratentorial primitive neuroectodermal and pineal tumors, visual pathway and hypothalamic glioma, Wilms' tumor, acute lymphocytic leukemia, adult acute myeloid leukemia, adult non-Hodgkin's lymphoma, chronic lymphocytic leukemia, chronic myeloid leukemia, esophageal cancer, hairy cell leukemia, kidney cancer, multiple myeloma, oral cancer, pancreatic cancer, primary central nervous system lymphoma, skin cancer, and small-cell lung cancer correlating the results from step (e) with the specificity of the antibody selectively binding the biotinylated constituent of the biosample, thereby detecting at least one biomarker.

In embodiments of the method of this aspect of the disclosure, the first biosample can be a biofluid, a cell suspension, a cell culture medium, or a cell lysate.

In embodiments of the method of this aspect of the disclosure, the second biosample can be a biofluid, a cell suspension, a cell culture medium, or a cell lysate.

In embodiments of the method of this aspect of the disclosure, the antibody array can comprise a plurality of antibody species capable of specifically capturing at least one biomarker characteristic of an ovarian cancer.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIG. 1 shows a series of digital images of fluorescence signals from array slides. Each purified antigen was biotinylated at 1,000 ng/ml in 1×PBS. Biotinylated antigen was diluted 10-fold with blocking buffer and incubated with an array slide. After extensive washes, fluorescence conjugated streptavidin was added to reveal the detectable signals.

FIG. 2A shows a table illustrating the reproducibility of the assay according to the present disclosure.

FIG. 2B illustrates a graphical scatter plot of normalized intensity from serum sample intra-slide on log scale. The base 2 values of the signal intensities for duplicates experiments are plotted. R2 is equal to 0.9240, indicating the reproducibility of two repeated experiments.

FIG. 3 is a graph illustrating the degree of detection of cancer cell markers in cell culture supernatant diluted to 2-, 10-, or 20-fold with blocking buffer and then incubated with human label-based antibody arrays according to the present disclosure.

FIGS. 4A-4H is a series of graphs illustrating the increases in detectable signal when individual proteins were artificially increased in concentration (“spiked”). Recombinant antigens were serially diluted into a human serum solution to give final concentrations of 50,000, 5,000, 500, 50 and 5 pg/ml. The sera containing the different concentrations of antigen were then labeled with biotin. The biotinylated samples were diluted 5-fold with blocking buffer and incubated with each array slide.

FIGS. 5A-5D show a series of graphs providing data from a validation assay for the methods of the disclosure. Conditioned medium was prepared from human glioblastome cells (U251) stimulated with or without TNFα. Both biotin label-based antibody arrays (FIGS. 5A and 5B) and ELISA (FIGS. 5C and 5D) were performed.

FIGS. 5E-5H show a series of graphs providing data from a validation assay for the methods of the disclosure. Conditioned medium was prepared from human breast cancer cells (MDA-MB-157 and T47D) stimulated with or without TNFα. Both biotin label-based antibody arrays (FIGS. 5E and 5F) and ELISA (FIGS. 5G and 5H) were performed.

FIG. 5I illustrates a mini map of the antibody arrays used to generate the results shown in FIGS. 5A-5H.

FIG. 6A is a graph illustrating the correlation for BDNF between biotin label-based antibody arrays according to the present disclosure and ELISA. The overall R value was larger than 0.9, suggesting a correlation between two assays.

FIG. 6B is a graph illustrating the correlation for Acrp-30 between biotin label-based antibody arrays according to the present disclosure and ELISA. The overall R value was larger than 0.9, suggesting a correlation between two assays.

FIG. 7 schematically illustrates a classification tree analysis that discriminates between ovarian cancer and normal controls by first searching the range of each potential cytokine marker, and then finding the split that maximized the likelihood of the given data set. Within each resulting subset, the algorithm again searched the range of each variable to choose the optimal split. This process continues until all observations are perfectly discriminated, or the sample size within a given subset is too small to divide further. Proteins used in the classification tree analysis and their cut off signal were listed on the right. The range of data specified at each split represents the subset of data which is further subdivided by branches to the right.

FIGS. 8A-8D illustrates the results of a Split-Point Score Analysis. The split point divides the sample space into two intervals, one for cancer and one for normal controls. The best split score of each marker will be chosen to ensure the least number of misclassified samples. A score of 0 is assigned to a sample if it falls in the normal control interval; a score of 1 is assigned to a sample if it falls in the cancer interval. Overall, an individual is assigned a score as the sum of these assigned scores from different markers. Therefore, the range of such score is between 0 to 6. FIG. 8A is a table showing 6 markers used in Split-point Score Classification Analysis. Misidentified samples were in the bracket using individual markers. FIG. 8B shows a dot histogram plot with six-analyte split-point score classification of serum samples from healthy controls (N) and individuals with ovarian cancers. Correctly classified normal serum samples should have a score of 0 to 2, whereas samples from ovarian cancer patients should have a score of 3, 4, 5 and 6. False-negative sample and false positive samples could be easily detected. FIG. 8C shows an ROC curve for a 5-marker panel of split score analysis of ovarian cancer versus healthy controls. ROC is the curve plotted by sensitivity (true positive) against 1-24 specificity (false positive) values. FIG. 8D shows a 2×2 table using 6-marker split-point score to diagnose ovarian cancer patients. A cut-off score of 3 is used.

The drawings are described in greater detail in the description and examples below.

The details of some exemplary embodiments of the methods and systems of the present disclosure are set forth in the description below. Other features, objects, and advantages of the disclosure will be apparent to one of skill in the art upon examination of the following description, drawings, examples and claims. It is intended that all such additional systems, methods, features, and advantages be included within this description, be within the scope of the present disclosure, and be protected by the accompanying claims.

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of medicine, organic chemistry, biochemistry, molecular biology, pharmacology, and the like, which are within the skill of the art. Such techniques are explained fully in the literature.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

As used herein, the following terms have the meanings ascribed to them unless specified otherwise. In this disclosure, “comprises,” “comprising,” “containing” and “having” and the like can have the meaning ascribed to them in U.S. Patent law and can mean “includes,” “including,” and the like; “consisting essentially of” or “consists essentially” or the like, when applied to methods and compositions encompassed by the present disclosure refers to compositions like those disclosed herein, but which may contain additional structural groups, composition components or method steps (or analogs or derivatives thereof as discussed above). Such additional structural groups, composition components or method steps, etc., however, do not materially affect the basic and novel characteristic(s) of the compositions or methods, compared to those of the corresponding compositions or methods disclosed herein. “Consisting essentially of” or “consists essentially” or the like, when applied to methods and compositions encompassed by the present disclosure have the meaning ascribed in U.S. Patent law and the term is open-ended, allowing for the presence of more than that which is recited so long as basic or novel characteristics of that which is recited is not changed by the presence of more than that which is recited, but excludes prior art embodiments.

Prior to describing the various embodiments, the following definitions are provided and should be used unless otherwise indicated.

### DEFINITIONS

In describing and claiming the disclosed subject matter, the following terminology will be used in accordance with the definitions set forth below.

As used herein, the terms “subject” and “patient” includes humans, mammals (e.g., cats, dogs, horses, etc.), living cells, and other living organisms. A living organism can be as simple as, for example, a single eukaryotic cell or as complex as a mammal. Typical hosts to which embodiments of the present disclosure may be administered will be mammals, particularly primates, especially humans. For veterinary applications, a wide variety of subjects will be suitable, e.g., livestock such as cattle, sheep, goats, cows, swine, and the like; poultry such as chickens, ducks, geese, turkeys, and the like; and domesticated animals particularly pets such as dogs and cats. For diagnostic or research applications, a wide variety of mammals will be suitable subjects, including rodents (e.g., mice, rats, hamsters), rabbits, primates, and swine such as inbred pigs and the like. In some embodiments, a system includes a sample and a subject. The term “living host” refers to host or organisms noted above that are alive and are not dead. The term “living host” refers to the entire host or organism and not just a part excised (e.g., a liver or other organ) from the living host.

The term “biomarker” as used herein refers to an antigen such as, but not limited to, a peptide, polypeptide, protein (monomeric or multimeric) that may be found on the surface of a cell, an intracellular component of a cell, or a component or constituent of a biofluid such as a soluble protein in a serum sample and which is a characteristic that is objectively measured and evaluated as an indicator of a tumor or tumor cell. The presence of such a biomarker in a biofluid or a biosample isolated from a subject human or animal can indicate that the subject is a bearer of a cancer. A change in the expression of such a biomarker may correlate with an increased risk of disease or progression, or predictive of a response of a disease to a given treatment. Exemplary biomarkers useful in the systems and methods of the disclosure can be, but are not limited to, such as activin A; IL-18 BPa, adiponectin/acrp30, IL-18 receptor α/IL-1 R5, AgRP, IL-18 receptor 13/AcPL, ALCAM, IL-2 receptor α, angiogenin, IL-2 receptor α, AR (amphiregulin), IL-3, Axl, IL-4, B7-1/CD80, I-TAC/CXCL11, BCMA/TNFRSF17, leptin (OB), BDNF, LIF, β-NGF, LIGHT/TNFSF14, BLC/BCA-1/CXCL13, LIGHT/TNFSF14, BMP-5, MCP-2, BTC, MCP-3, cardiotrophin-1/CT-1, MCP-4/CCL13, CTLA-4/CD152, M-CSF, CXCL16, MMP-10, Dtk, MMP-13, EGF, MMP-9, EGF receptor/ErbB1, MSP α-chain, endoglin/CD105, MSP β-chain, eotaxin/CCL11, NAP-2, eotaxin-2/MPIF-2, NGF R, eotaxin-3/CCL26, NT-4, ErbB3, OSM, Fas/TNFRSF6, osteoprotegerin, Fas Ligand, PDGF receptor β, FGF Basic, PDGF-AA, FGF-4, PDGF-AB, FGF-6, PDGF-BB, FGF-7/KGF, PIGF, FGF-9, P-selectin, follistatin, RAGE, GITR/TNFRF18, RANTES, HB-EGF, SCF, HCC-4/CCL16, SCF receptor/CD117, HGF, sgp130, I-309, Siglec-9, IGFBP-1, siglec-5/CD170, IGFBP-2, Tarc, IGFBP-3, TGFα, IGF-I, TNF RI/TNFRSF1A, IGF-I, TNF R11/TNFRSF1B, IGF-I S receptor, TNFβ, IGF-II, TRAIL R1/DR4/TNFRSF 10/, IGF-II, TRAIL R3/TNFRSF 10C, IL-1α, TRAIL R4/TNFRSF 10D, IL-1β, TRANCE, IL-1 R4/ST2, TREM-1, IL-1 sRI, TROP/TNFRSF19, IL-1 sRI, uPAR, IL-10, VCAM-1 (CD106), IL-10 receptor β, VE-cadherin, IL-13 receptor α1, VEGF, IL-13 receptor α2, VEGF R2 (KDR), IL-17, VEGF R3, and the like, or any combination thereof. It is considered within the scope of the disclosure for a cancer or cancer cell to be characterized by at least one biomarker and more typically by a plurality (a panel) of such markers.

The term “cancer”, as used herein, shall be given its ordinary meaning, as a general term for diseases in which abnormal cells divide without control. In particular, cancer refers to angiogenesis related cancer. Cancer cells can invade nearby tissues and can spread through the bloodstream and lymphatic system to other parts of the body.

There are several main types of cancer, for example, carcinoma is cancer that begins in the skin or in tissues that line or cover internal organs. Sarcoma is cancer that begins in bone, cartilage, fat, muscle, blood vessels, or other connective or supportive tissue. Leukemia is cancer that starts in blood-forming tissue such as the bone marrow, and causes large numbers of abnormal blood cells to be produced and enter the bloodstream. Lymphoma is cancer that begins in the cells of the immune system.

When normal cells lose their ability to behave as a specified, controlled and coordinated unit, a tumor is formed. Generally, a solid tumor is an abnormal mass of tissue that usually does not contain cysts or liquid areas (some brain tumors do have cysts and central necrotic areas filled with liquid). A single tumor may even have different populations of cells within it, with differing processes that have gone awry. Solid tumors may be benign (not cancerous), or malignant (cancerous). Different types of solid tumors are named for the type of cells that form them. Examples of solid tumors are sarcomas, carcinomas, and lymphomas. Leukemias (cancers of the blood) generally do not form solid tumors.

Representative cancers include, but are not limited to, bladder cancer, breast cancer, colorectal cancer, endometrial cancer, head and neck cancer, leukemia, lung cancer, lymphoma, melanoma, non-small-cell lung cancer, ovarian cancer, prostate cancer, testicular cancer, uterine cancer, cervical cancer, thyroid cancer, gastric cancer, brain stem glioma, cerebellar astrocytoma, cerebral astrocytoma, glioblastoma, ependymoma, Ewing's sarcoma family of tumors, germ cell tumor, extracranial cancer, Hodgkin's disease, leukemia, acute lymphoblastic leukemia, acute myeloid leukemia, liver cancer, medulloblastoma, neuroblastoma, brain tumors generally, non-Hodgkin's lymphoma, osteosarcoma, malignant fibrous histiocytoma of bone, retinoblastoma, rhabdomyosarcoma, soft tissue sarcomas generally, supratentorial primitive neuroectodermal and pineal tumors, visual pathway and hypothalamic glioma, Wilms' tumor, acute lymphocytic leukemia, adult acute myeloid leukemia, adult non-Hodgkin's lymphoma, chronic lymphocytic leukemia, chronic myeloid leukemia, esophageal cancer, hairy cell leukemia, kidney cancer, multiple myeloma, oral cancer, pancreatic cancer, primary central nervous system lymphoma, skin cancer, small-cell lung cancer, among others.

A tumor can be classified as malignant or benign. In both cases, there is an abnormal aggregation and proliferation of cells. In the case of a malignant tumor, these cells behave more aggressively, acquiring properties of increased invasiveness. Ultimately, the tumor cells may even gain the ability to break away from the microscopic environment in which they originated, spread to another area of the body (with a very different environment, not normally conducive to their growth), and continue their rapid growth and division in this new location. This is called metastasis. Once malignant cells have metastasized, achieving a cure is more difficult.

Benign tumors have less of a tendency to invade and are less likely to metastasize. Brain tumors spread extensively within the brain but do not usually metastasize outside the brain. Gliomas are very invasive inside the brain, even crossing hemispheres. They do divide in an uncontrolled manner, though. Depending on their location, they can be just as life threatening as malignant lesions. An example of this would be a benign tumor in the brain, which can grow and occupy space within the skull, leading to increased pressure on the brain.

The term “biofluid” as used herein refers to a biological fluid sample encompasses a variety of fluid sample types obtained from an individual and can be used in a diagnostic or monitoring assay. The definition encompasses blood total or serum), cerebral spinal fluid (CSF), urine and other liquid samples of biological origin. The definition also includes samples that have been manipulated in any way after their procurement, such as by treatment with reagents, solubilization, or enrichment for certain components, such as proteins or polynucleotides.

The term “blood sample” is a biological sample which is derived from blood, preferably peripheral (or circulating) blood. A blood sample may be, for example, whole blood, plasma, serum, or a solubilized preparation of such fluids wherein the cell components have been lysed to release interacellular contents into a buffer or other liquid medium.

Throughout the present application, the terms “antibody”, “antigen”, “antibody array”, and “detecting agents” are used for the simplicity of description. The term “antibody” as used herein can encompass monoclonal, polyclonal antibodies, chimeric antibodies, single chain, and mutants thereof. Antibodies may be derived from any source, including, but not limited to, murine spp., rat, rabbit, chicken, human, or any other origin (including humanized antibodies). Techniques for the generation of antibodies that can specifically recognize and bind to are known in the art.

The term “antigen” as used herein refers to any entity that binds to an antibody disposed on an antibody array and induces at least one shared conformational epitope on the antibody. Antigens could be proteins, peptides, antibodies, small molecules, lipid, carbohydrates, nucleic acid, and allergens. An antigen may be in its pure form or in a sample in which the antigen is mixed with other components.

The term “antibody array” as used herein refers to a linear or two-dimensional array of two or more different antibodies formed on the surface of a solid support.

The term “detecting agent” as used herein refers to any detectable biotin-binding polypeptide such as, but not limited to, avidin, streptavidin, and sequence variants thereof, that retain the ability to selectively bind biotin moieties and which have a detectable moiety conjugated or otherwise attached thereto. The detecting agent will not bind, or bind at an insignificant level, the antibodies immobilized on an antibody array if the antibodies are not bound with their corresponding biotin-conjugated antigens.

The term “antibody array” as used herein refers to an ordered spatial arrangement of two or more antibodies on a physical substrate. Row and column arrangements are preferred due to the relative simplicity in making and assessing such arrangements. The spatial arrangement can, however, be essentially any form selected by the user, and preferably but need not be, in a pattern. The most common form of antibody array is where antibodies that bind specific antigens are arrayed on a glass slide at high density. A sample containing possible antigens is passed over the array and the bound antigen is detected after washing.

The antibodies in an antibody any are preferably printed onto a solid support. Amongst the large number of solid-support materials applicable for the production of antibody arrays, silica or glass is most often used because of its great chemical resistance against solvents, its mechanical stability, its low intrinsic fluorescence properties, and its flexibility of being readily functionalized. Examples of well known solid supports include polypropylene, polystyerene, polyethylene, dextran, nylon, amylases, glass, natural and modified celluloses, polyacrylamides, agaroses and magnetite. Those skilled in the art will know of other suitable solid support for binding antibodies, or will be able to ascertain such, using routine experimentation.

Antibodies may be immobilized onto a support surface either by chemical ligation through a covalent bond or non-covalent binding. There are many known methods for covalently immobilizing antibodies onto a solid support. For example, MacBeath et al., (1999) J. Am. Chem. Soc. 121: 7967-7968) use the Michael addition to link thiol-containing compounds to maleimide-derivatized glass slides to form a microarray of small molecules. (See also, Lam & Renil (2002) Current Opin. Chemical Biol. 6:353-358).

Antibodies may be attached to various kinds of surface via diffusion, adsorption/absorption, or covalent cross-linking and affinity. Antibodies may be directly spotted onto plain glass surface. To keep antibodies in a wet environment during the printing process, high percent glycerol (30-40%) may be used in sample buffer and the spotting is carried out in a humidity-controlled environment.

The surface of a substrate may be modified to achieve better binding capacity. For example, the glass surface may be coated with a thin nitrocellulose membrane or poly-L-lysine such that antibodies can be passively adsorbed to the modified surface through non-specific interactions.

Antibody arrays can be fabricated by the transfer of antibodies onto the solid surface in an organized high-density format followed by chemical immobilization. The techniques for fabrication of an array include, but are not limited to, photolithography, ink jet and contact printing, liquid dispensing and piezoelectrics. The patterns and dimensions of antibody arrays are to be determined by each specific application. The sizes of each antibody spots may be easily controlled by the users.

By “detectably labeled” is meant that a biotin-binding polypeptide or a fragment thereof, contains a moiety that is radioactive, or that is substituted with a fluorophore, or that is substituted with some other molecular species that elicits a physical or chemical response that can be observed or detected by the naked eye or by means of instrumentation such as, without limitation, scintillation counters, colorimeters, UV spectrophotometers and the like.

The term “detectable moiety” as used herein refers to various labeling moieties known in the art. Said moiety may be, for example, a radiolabel (e.g., ³H, ¹²⁵I, ³⁵S, ¹⁴C, ³²P, etc.), detectable enzyme (e.g., horse radish peroxidase (HRP), alkaline phosphatase etc.), a dye, a colorimetric label such as colloidal gold or colored glass or plastic (e.g., polystyrene, polypropylene, latex, etc.), beads, or any other moiety capable of generating a detectable signal such as a colorimetric, fluorescent, chemiluminescent or electrochemiluminescent (ECL) signal.

The term “dye” as used herein refers to any reporter group whose presence can be detected by its light absorbing or light emitting properties. For example, Cy5 is a reactive water-soluble fluorescent dye of the cyanine dye family. Cy5 is fluorescent in the red region (about 650 to about 670 nm). It may be synthesized with reactive groups on either one or both of the nitrogen side chains so that they can be chemically linked to either nucleic acids or protein molecules. Labeling is done for visualization and quantification purposes. Cy5 is excited maximally at about 649 nm and emits maximally at about 670 nm, in the far red part of the spectrum; quantum yield is 0.28. FW=792. Suitable fluorophores (chromes) for the probes of the disclosure may be selected from, but not intended to be limited to, fluorescein isothiocyanate (FITC, green), cyanine dyes Cy2, Cy3, Cy3.5, Cy5, Cy5.5 Cy7, Cy7.5 (ranging from green to near-infrared), Texas Red, and the like. Derivatives of these dyes for use in the embodiments of the disclosure may be, but are not limited to, Cy dyes (Amersham Bioscience), Alexa Fluors (Molecular Probes Inc.), HILYTE™ Fluors (AnaSpec), and DYLITE™ Fluors (Pierce, Inc).

The term “fluorescence” as used herein refers to a luminescence that is mostly found as an optical phenomenon in cold bodies, in which the molecular absorption of a photon triggers the emission of a photon with a longer (less energetic) wavelength. The energy difference between the absorbed and emitted photons ends up as molecular rotations, vibrations or heat. Sometimes the absorbed photon is in the ultraviolet range, and the emitted light is in the visible range, but this depends on the absorbance curve and Stokes shift of the particular fluorophore.

Spectroscopic, photochemical, biochemical, immunochemical, electrical, optical or chemical means can be used to detect such labels. The detection device and method may include, but is not limited to, optical imaging, electronic imaging, imaging with a CCD camera, integrated optical imaging, and mass spectrometry. Further, the amount of labeled or unlabeled probe bound to the target may be quantified. Such quantification may include statistical analysis.

The term “comparing the results of steps” as used herein refers to comparing the results of contacting identical antibody arrays with: (i) a biotinylated biofluid isolated from a first subject human or animal suspected of having a cancer or cancer cell and determining the presence of biomarkers in such a biotinyated sample, and (ii) a biotinylated biofluid isolated from a second subject human or animal known not to have a cancer or cancer cell and determining the presence of biomarkers in such a biotinyated sample. Detectable biomarkers found in (i) but not in (ii) can indicate that such differentially expressed biomarkers are characteristic of the cancer or cancer cell in the first subject human or animal.

### Abbreviations:

ANOVA, analysis of variance; Acrp30, adipocytes complement related protein 30 kDa (adiponectin); ALCAM, activated leukocyte cell adhesion molecule; BDNF, brain-derived neurotrophic factor; BLC, B-lymphocyte chemoattractant; BMP, bone morphogenetic protein; BTC, β-cellulin; CCR, CC-chemokine receptor; CLC, cardiotrophin-like cytokine; CV, coefficient of variance; CXCR, CXC-chemokine receptor; DAB, 3,3′-diaminobenzidine; DAN, differential screening-selected gene aberrative in neuroblastoma; ECL, enhanced chemiluminescence; EDG-1, estrogen down-regulated gene 1; EGF, epidermal growth factor; ELISA, enzyme-linked immunosorbant assay; ET-1, endothelin 1; ETAR, endothelin receptor type A; FGF, fibroblast growth factor; GDF, growth and differentiation factor; GFR. Glial cell line-derived neurotrophic factor receptor; GITR, glucocorticoid induced tumor necrosis factor receptor family related gene; HB-EGF, heparin-binding EGF-like factor; HCC, hemofiltrate CC chemokine; HRP, horseradish peroxidase; ICAM, intercellular adhesion molecule; IFN, interferon; IGF, insulin-like growth factor; IGFBP, insulin-like growth factor binding protein; IgG, immunoglobulin gamma; IL, interleukin; I-TAC, Interferon-inducible T-cell alpha chemoattractant; LCK, lymphocyte cell-specific protein-tyrosine kinase; LIF, leukemia inhibitory factor; MCP, monocytes chemoattractant protein; M-CSF, macrophage colony stimulating factor; MIP, macrophage inflammatory protein; MMP, matrix metalloproteinase; MSP, macrophage stimulating protein; NAP, neural antiproliferation factor; NGF, nerve growth factor; NRG, neuregulin; NT, neurotensin; PDGF, platelet-derived growth factor; PIGF, placental growth factor; RAGE, Receptor for advanced glycosylation end products; RIPA, radioimmunopreciptiation assay; SCF, stem cell factor; TARC, thymus- and activation-regulated chemokine; TGF, transforming growth factor; TIMP, tissue inhibitor of metalloproteinases; TNF, tumor necrosis factor; TNFRSF, TNF receptor superfamily member; TNFSF, TNF superfamily member; TRAIL, TNF-related apoptosis inducing ligand; TRANCE, tumor necrosis factor-related activation induced cytokine; TREM, triggering receptor expressed on myeloid cells; TSG, TNF stimulated gene; uPAR, urokinase plasminogen activator receptor; VCAM, vascular cellular adhesion molecule; VEGF, vascular endothelial growth factor.

### Description

Profiling protein expression on a global scale will have significant impact on biomedical research, particularly in the discovery and development of drugs and biomarkers. Through the years, several antibody array systems have been invented and developed for multiple protein detection. However, a reliable and high-content system for protein profiling from many biological samples has yet developed. This study is to develop a reliable, easy to use and cost effective method to profile protein expression levels in high-content manner with sufficient sensitivity and specificity.

The present disclosure provides systems and methods for identifying biomarker panels that are characteristic for a cancer or a cancer cell. In these methods, a biosample is obtained from a subject human or animal that is suspected of having a targeted cancer. It is contemplated that the biosample may be a biofluid such as a blood sample or the serum thereof, lymph, and the like, or a solid tissue sample. The biosample contemplated as being characterized by the methods of the disclosure may also be a cultured population of cells derived from the subject human or animal. However, whenever the biosample comprises a population of cells, the method will first require that the constituents of the cells be solubilized by lysing the cells, and removing solid cell debris, thereby providing a solution of the potential biomarkers.

The biofluid is then contacted with a system of reagents, well-known in the art, that can attach biotin moieties to some or all of the constituent components of the biofluid, and especially to the protein or peptide constituents thereof. Following this biotinylation step, the biotinylated biofluid may then be contacted with an antibody array that comprises an array of antibody species attached to a solid phase substrate, each antibody species characterized as capable of selectively binding to a particular biomarker protein or peptide.

After an adequate incubation period, readily selected to allow the binding of any biomarker in the biofluid to its corresponding antibody of the array, the biofluid is washed from the array. The array is then contacted with a biotin-binding polypeptide such as, but not limited to, avidin or streptavidin, that has been conjugated with a detectable label. It is contemplated that the system and methods of the disclosure can be readily adapted to use any detectable label such as, but not limited to, a fluorescent dye, a non-fluorescent dye, a radioactive tracer, and the like.

Detection of the label on the array will indicate which of the biomarkers captured by the antibody having affinity thereof is present in the biofluid sample. To determine which biomarkers are specific to the target cancer or cancer cell (as opposed to being generally or non-specifically found in many or all biosamples), two parallel assays may be performed, using identical antibody arrays. One biosample will be isolated from a first subject human or animal that is suspected of having a cancer or cancer cell, biotinylated and contacted to one array, while a second biosample, from a subject known not to have the cancer or cancer cell, will be biotinylated and contacted to the second array. After exposure of the two sets of arrays to the biotin-binding labeled polypeptide, detection of differences in the patterns of labeling of the two antibody array sets will indicate which biomarkers are specific to the target cancer.

It is further contemplated that the biotin-label assay of the present disclosure may use antibody arrays where the panel of antibodies is limited to those antibodies having specific affinity for the biomarkers specific to a target cancer. Such assay systems may be useful for detecting the target cancer in a biosample or plurality of biosamples, or may be used, for example, to monitor the change in the progress or reduction in the target cancer in a subject human or animal.

Using this biotin-label-based antibody array technology, the expression levels of several hundred human, mouse, or rat target proteins could be simultaneously detected, including cytokines, chemokines, adipokines, growth factors, angiogenic factors, proteases, soluble receptors, soluble adhesion molecules, and other proteins in a variety of samples. Most proteins could be detected at pg/ml and ng/ml levels. In one example, but not intended to be limiting, using human biotin-based antibody arrays, the serum expression profiles of as many as 507 proteins in ovarian cancer patients and normal subjects were screened. A panel of protein expression showed significant differences between normal and cancer (P<0.05). By Classification Analysis and Split-Point Score Analysis of these two groups, a small group of proteins could be used to distinguish ovarian cancer patients from normal subjects.

In the last decade, several different formats of antibody arrays have been developed. The underlying principle of this technology is the interaction between capture antibodies printed on the solid surface in predetermined positions and the corresponding target antigens. To detect this interaction, a variety of detection methods can be used. The most common way is to apply detection antibodies that recognize the different epitopes of same target protein. In practical application, this is the most common format since the whole procedure can be easily adapted to automation. This approach also can semi-quantitatively and quantitatively measure protein levels with high specificity, sensitivity and reproducibility. However, the limited source of pair antibodies and the cross-reactivity among capture and detection antibodies significantly hinders the potential for the development of high density antibody arrays.

Surface Plasmon Resonance (SPR) detection provides a label-free and single antibody approach whereby proteins in the sample are captured by antibodies printed on the arrays, and detected by light scatter reflection due to the interaction between capture antibody and the target protein. The major advantage of this SPR method is its ability to measure the relative amount of protein levels, to monitor the affinity constant in real time, and no label is required. However, this approach suffers from low detection sensitivity and still needs to await improvements in instrumentation for high density detection.

Combinations of antibody arrays and mass spectrophotometry may ultimately provide a solution for detection of protein levels with high content, high throughput and specificity, but the technology has not matured enough for routine clinical application, and it lacks the sensitivity required for biomarker discovery (Ray et al., (2007) Nat. Med. 13: 1359-1362; Doucet & Overall (2008) Mol. Aspects Med. 29: 339-358).

A current approach for high density antibody arrays is to label protein with a fluorescence dye. Most of fluorescence dyes used in the antibody arrays are cy3 18 and cy5 as in DNA microarrays (Haab et al., (2001) Genome Biol. 2: RESEARCH0004; Celis et al., (2005) Mol. Cell Proteomics 4: 492-522). An inherent problem, however, in using fluorescence dye-labeling is low detection sensitivity. To increase the detection sensitivity, biotin-label-based antibody arrays have been developed.

The biotin-label-based array methods of the present disclosure have several advantages over fluorescence label. Biotin-label can be used as signal amplification. Biotin is the most common method for labeling protein and the label process can be highly efficient. Furthermore, biotin can be detected using fluorescence-streptavidin and, therefore, visualized using laser scanner, or by using HRP-streptavidin imaged using chemiluminescence. The results of the present disclosure show that using biotin-label-based antibody arrays, most targeted proteins can be detected at pg/ml levels. It is further contemplated, however, that the detection sensitivity of the present methods can be further enhanced by using 3-DNA detection technology or rolling circle amplification (Schweitzer et al., (2000) Proc. Natl. Acad. Sci. U.S.A. 97: 10113-10119; Horie et al., (1996) Int. J. Hematol. 63: 303-309).

Accordingly, several distinct detection methods can be used in this biotin-label approach. For example, but not intended to be limiting, fluorescence detection may be used, wherein the system can use glass slides. If chemiluminescence detection is used, the signal can be visualized using chemiluminescence imager or x-ray processor. If colorimeter detection is used, no detection equipment is required, visual observation detecting the color development.

Although only one antibody is used so that there is no interaction between the capture antibody and the detection antibody, detection specificity is lower compared with the sandwich-based (pair antibody) format. However, it can also avoid the cross-reactivity caused by detection antibody. By selection of high-specificity antibodies, the cross-reactivity issue can be reduced to acceptable levels and, as has been demonstrated in this examples, target-specific detection can be achieved.

The content of arrays can be readily expanded and changed. For instance, it was possible to develope biotin label-based mouse antibody arrays to detect the expression levels of 304 mouse proteins, biotin label-based rat antibody arrays to detect the expression levels of about 90 rat proteins, and biotin label-based human adipokine antibody arrays to detect the expression levels of about 180 adipokines. These high density antibody arrays are particularly useful in biomarker screening and expression profiling. In one example, to demonstrate such applications, as many as 507 human protein levels were screened in ovarian cancer specimens and normal subjects. It was found that a panel of serum proteins was differentially expressed (P<0.05) between ovarian cancer patients and normal subjects and a group of proteins were identified useful in distinguishing ovarian cancer-bearing individuals from normal subjects, suggesting that the assay methods of the present disclosure is a useful approach in biomarker discovery.

The six ovarian cancer-related biomarkers identified are all involved in angiogenesis. All of the markers identified by the biotin label-based antibody array method of the present disclosure have been reported to play role in solid tumor development and/or progression. For example, ET-1 has been implicated in the pathophysiology of a wide range of human tumors, including ovarian carcinoma (Bagnato et al., (2005) Endocr. Relat. Cancer 12: 761-772). Salani et al. reported the role of ET-1 in the neovascularization of ovarian carcinoma, postulating that ET-1 could modulate tumor angiogenesis, acting directly and in part through VEGF (Salani et al., (2000) Am. J. Pathol. 157: 1703-1711). ET-1 has also been reported to play an important role in ovarian cancer progression. Rosano et al. reported that ETAR activation by ET-1 contributes to tumor progression by acting as a crucial mediator of epithelial to-mesenchymal transition (EMT) in human ovarian carcinoma cells (Rosano et al., (2005) Cancer Res. 65: 11649-11657). sIL-2R has been found in elevated levels in sera from patients with several types of solid tumors, including ovarian cancers. Sedlaczek, and Gebauer et al., both reported that sIL-2R was highly expressed in ascites and sera of ovarian cancer patients compared with benign tumors (Sedlaczek et al., (2002) Cancer 95: 1886-1893; Gebauer et al., (1999) Anticancer Res. 19: 2509-2511). Osteoactivin has been reported to play a role in some solid tumors including hepatocellular carcinoma, breast cancer, melanoma and glioma. Onaga et al. have reported that over-expression of osteoactivin may be involved in the progression of hepatocellular carcinoma cells via stimulation of tumor invasiveness and metastatic potential (Onaga et al., (2003) J. Hepatol. 39: 779-785). Rose et al. has reported that osteoactivin plays role in promoting breast cancer metastisis to bone.

One aspect of the present disclosure, therefore, encompasses embodiments of systems for identifying at least one biomarker characteristic of a cancer or a cancer cell, the system comprising: (a) an antibody array comprising at least one antibody species capable of capturing a biomarker characteristic of a cancer or a cancer cell; (b) a system for biotinylating at least one biomarker of a biosample obtained from a subject human or animal; and (c) a detectable biotin-binding polypeptide.

In embodiments of this aspect of the disclosure, the system can further comprise a system to detect the biotin-binding polypeptide.

In embodiments of this aspect of the disclosure, the system can further comprise a system for solubilizing the at least one biomarker of a biosample obtained from a subject human or animal.

In some embodiments of this aspect of the disclosure, the system can further comprise a system for solubilizing the at least one biomarker of a biosample obtained from a subject human or animal comprises a system for lysing cells of the biosample.

In the embodiments of this aspect of the disclosure, the biomarker, or a plurality of said biomarkers, can be selected from the group consisting of: activin A; IL-18 BPa, adiponectin/acrp30, IL-18 receptor α/IL-1 R5, AgRP, IL-18 receptor 13/AcPL, ALCAM, IL-2 receptor α, angiogenin, IL-2 receptor α, AR (amphiregulin), IL-3, Axl, IL-4, B7-1/CD80, I-TAC/CXCL11, BCMA/TNFRSF17, leptin (OB), BDNF, LIF, β-NGF, LIGHT/TNFSF14, BLC/BCA-1/CXCL13, LIGHT/TNFSF14, BMP-5, MCP-2, BTC, MCP-3, cardiotrophin-1/CT-1, MCP-4/CCL13, CTLA-4/CD152, M-CSF, CXCL16, MMP-10, Dtk, MMP-13, EGF, MMP-9, EGF receptor/ErbB1, MSP α-chain, endoglin/CD105, MSP β-chain, Eotaxin/CCL11, NAP-2, eotaxin-2/MPIF-2, NGF R, eotaxin-3/CCL26, NT-4, ErbB3, OSM, Fas/TNFRSF6, osteoprotegerin, Fas Ligand, PDGF receptor β, FGF Basic, PDGF-AA, FGF-4, PDGF-AB, FGF-6, PDGF-BB, FGF-7/KGF, PIGF, FGF-9, P-selectin, follistatin, RAGE, GITR/TNFRF18, RANTES, HB-EGF, SCF, HCC-4/CCL16, SCF receptor/CD117, HGF, sgp130, I-309, Siglec-9, IGFBP-1, siglec-5/CD170, IGFBP-2, Tarc, IGFBP-3, TGFα, IGF-I, TNF RI/TNFRSF1A, IGF-I, TNF RII/TNFRSF1B, IGF-I S receptor, TNFβ, IGF-II, TRAIL R1/DR4/TNFRSF 10/, IGF-II, TRAIL R3/TNFRSF 10C, IL-1α, TRAIL R4/TNFRSF 10D, IL-16, TRANCE, IL-1 R4/ST2, TREM-1, IL-1 sRI, TROP/TNFRSF19, IL-1 sRI, uPAR, IL-10, VCAM-1 (CD106), IL-10 receptor β, VE-cadherin, IL-13 receptor α1, VEGF, IL-13 receptor α2, VEGF R2 (KDR), IL-17, VEGF R3, or any combination thereof.

In embodiments of this aspect of the disclosure, the antibody array can comprise a plurality of antibody species capable of specifically capturing at least one biomarker characteristic of a cancer or a cell thereof, wherein the cancer is selected from the group consisting of: bladder cancer, breast cancer, colorectal cancer, endometrial cancer, head and neck cancer, leukemia, lung cancer, lymphoma, melanoma, non-small-cell lung cancer, ovarian cancer, prostate cancer, testicular cancer, uterine cancer, cervical cancer, thyroid cancer, gastric cancer, brain stem glioma, cerebellar astrocytoma, cerebral astrocytoma, glioblastoma, ependymoma, Ewing's sarcoma family of tumors, germ cell tumor, extracranial cancer, Hodgkin's disease, leukemia, acute lymphoblastic leukemia, acute myeloid leukemia, liver cancer, medulloblastoma, neuroblastoma, brain tumors generally, non-Hodgkin's lymphoma, osteosarcoma, malignant fibrous histiocytoma of bone, retinoblastoma, rhabdomyosarcoma, soft tissue sarcomas generally, supratentorial primitive neuroectodermal and pineal tumors, visual pathway and hypothalamic glioma, Wilms' tumor, acute lymphocytic leukemia, adult acute myeloid leukemia, adult non-Hodgkin's lymphoma, chronic lymphocytic leukemia, chronic myeloid leukemia, esophageal cancer, hairy cell leukemia, kidney cancer, multiple myeloma, oral cancer, pancreatic cancer, primary central nervous system lymphoma, skin cancer, and small-cell lung cancer.

In embodiments of this aspect of the disclosure, the antibody array can comprise a plurality of antibody species capable of specifically capturing at least one biomarker characteristic of an ovarian cancer.

In embodiments of this aspect of the disclosure, the biotin-binding polypeptide can be avidin or streptavidin, or a biotin-binding variant thereof, and the biotin-binding polypeptide can be conjugated to a detectable labeling moiety.

In embodiments of this aspect of the disclosure, the detectable labeling moiety can be a dye, a fluorescent moiety, or an enzyme. In other embodiments of this aspect of the disclosure, the enzyme is a horse radish peroxidase. In yet other embodiments of this aspect of the disclosure, the detectable labeling moiety is a dye.

Another aspect of the disclosure encompasses embodiments of method of detecting at least one biomarker characteristic of a cancer or a cancer cell, the method comprising: (a) obtaining a first biosample from a first subject human or animal; (b) biotinylating at least constituent of the first biosample; (c) contacting the biotinylated first biosample to a first antibody array, said first antibody array comprising at least one antibody species capable of capturing a biomarker characteristic of a cancer or a cancer cell, under conditions whereby a biomarker can selectively bind to an antibody of the first antibody array; (d) contacting the first antibody array with a detectable biotin-binding polypeptide under conditions whereby the detectable biotin-binding polypeptide can selectively bind to a biotin moiety conjugated to a biomarker of the first biosample, wherein said biomarker is selectively bound to an antibody of the antibody array; and (e) detecting the detectable biotin-binding polypeptide bound to a biotin moiety conjugated to a biomarker of the biosample, wherein said biomarker is selectively bound to an antibody of the first antibody array.

In embodiments of the method of this aspect of the disclosure, the first biosample can be obtained from a subject human or animal having a cancer, and further comprising the steps of: (f) obtaining a second biosample from a second subject human or animal not having a cancer; (g) contacting the second biosample with a system for biotinylating a constituent of the second biosample; (h) contacting the biotinylated second biosample to a second antibody array, where the first and the second antibody arrays are identical, and under conditions whereby a biomarker can selectively bind to an antibody of the second antibody array; (i) contacting the second antibody array with a detectable biotin-binding polypeptide under conditions whereby the detectable biotin-binding polypeptide can selectively bind to a biotin moiety conjugated to a constituent of the second biosample, wherein said constituent is a biomarker selectively bound to an antibody of the second antibody array; (j) detecting the detectable biotin-binding polypeptide bound to a biotin moiety conjugated to a constituent of the second biosample, wherein said constituent is a biomarker selectively bound to an antibody of the second antibody array; and (k) comparing the results of steps (e) and (j), whereupon a detectable signal on the first antibody array but not on the second antibody array indicates the identity of a biomarker characteristic of the cancer of the first subject human or animal.

In embodiments of the method of this aspect of the disclosure, the detectable biotin-binding polypeptide can be an avidin, a streptavidin, or a biotin-binding variant thereof, and wherein the detectable biotin-binding polypeptide can be conjugated to a detectable labeling moiety.

In embodiments of the method of this aspect of the disclosure, the biomarker, or a plurality of said biomarkers, can be selected from the group consisting of: activin A; IL-18 BPa, adiponectin/acrp30, IL-18 receptor alpha/IL-1 R5, AgRP, IL-18 receptor β/AcPL, ALCAM, IL-2 receptor α, angiogenin, IL-2 receptor α, AR (amphiregulin), IL-3, Axl, IL-4, B7-1/CD80, I-TAC/CXCL11, BCMA/TNFRSF17, leptin (OB), BDNF, LIF, β-NGF, LIGHT/TNFSF14, BLC/BCA-1/CXCL13, LIGHT/TNFSF14, BMP-5, MCP-2, BTC, MCP-3, cardiotrophin-1/CT-1, MCP-4/CCL13, CTLA-4/CD152, M-CSF, CXCL16, MMP-10, Dtk, MMP-13, EGF, MMP-9, EGF receptor/ErbB1, MSP α-chain, endoglin/CD105, MSP β-chain, Eotaxin/CCL11, NAP-2, eotaxin-2/MPIF-2, NGF R, eotaxin-3/CCL26, NT-4, ErbB3, OSM, Fas/TNFRSF6, osteoprotegerin, Fas Ligand, PDGF receptor β, FGF Basic, PDGF-AA, FGF-4, PDGF-AB, FGF-6, PDGF-BB, FGF-7/KGF, PIGF, FGF-9, P-selectin, follistatin, RAGE, GITR/TNFRF18, RANTES, HB-EGF, SCF, HCC-4/CCL16, SCF receptor/CD117, HGF, sgp130, I-309, Siglec-9, IGFBP-1, siglec-5/CD170, IGFBP-2, Tarc, IGFBP-3, TGFα, IGF-I, TNF RI/TNFRSF1A, IGF-I, TNF R11/TNFRSF1B, IGF-I S receptor, TNFβ, IGF-II, TRAIL R1/DR4/TNFRSF 10/, IGF-II, TRAIL R3/TNFRSF 10C, IL-1α, TRAIL R4/TNFRSF 10D, IL-1β, TRANCE, IL-1 R4/ST2, TREM-1, IL-1 sRI, TROP/TNFRSF19, IL-1 sRI, uPAR, IL-10, VCAM-1 (CD106), IL-10 receptor β, VE-cadherin, IL-13 receptor α1, VEGF, IL-13 receptor α2, VEGF R2 (KDR), IL-17, VEGF R3, or any combination thereof.

In embodiments of the method of this aspect of the disclosure, the antibody array comprises a plurality of antibody species capable of specifically capturing at least one biomarker characteristic of a cancer or a cell thereof, wherein the cancer can be selected from the group consisting of: bladder cancer, breast cancer, colorectal cancer, endometrial cancer, head and neck cancer, leukemia, lung cancer, lymphoma, melanoma, non-small-cell lung cancer, ovarian cancer, prostate cancer, testicular cancer, uterine cancer, cervical cancer, thyroid cancer, gastric cancer, brain stem glioma, cerebellar astrocytoma, cerebral astrocytoma, glioblastoma, ependymoma, Ewing's sarcoma family of tumors, germ cell tumor, extracranial cancer, Hodgkin's disease, leukemia, acute lymphoblastic leukemia, acute myeloid leukemia, liver cancer, medulloblastoma, neuroblastoma, brain tumors generally, non-Hodgkin's lymphoma, osteosarcoma, malignant fibrous histiocytoma of bone, retinoblastoma, rhabdomyosarcoma, soft tissue sarcomas generally, supratentorial primitive neuroectodermal and pineal tumors, visual pathway and hypothalamic glioma, Wilms' tumor, acute lymphocytic leukemia, adult acute myeloid leukemia, adult non-Hodgkin's lymphoma, chronic lymphocytic leukemia, chronic myeloid leukemia, esophageal cancer, hairy cell leukemia, kidney cancer, multiple myeloma, oral cancer, pancreatic cancer, primary central nervous system lymphoma, skin cancer, and small-cell lung cancer correlating the results from step (e) with the specificity of the antibody selectively binding the biotinylated constituent of the biosample, thereby detecting at least one biomarker.

In embodiments of the method of this aspect of the disclosure, the first biosample can be a biofluid, a cell suspension, a cell culture medium, or a cell lysate.

In embodiments of the method of this aspect of the disclosure, the second biosample can be a biofluid, a cell suspension, a cell culture medium, or a cell lysate.

In embodiments of the method of this aspect of the disclosure, the antibody array can comprise a plurality of antibody species capable of specifically capturing at least one biomarker characteristic of an ovarian cancer.

The specific examples below are to be construed as merely illustrative, and not limitative of the remainder of the disclosure in any way whatsoever. Without further elaboration, it is believed that one skilled in the art can, based on the description herein, utilize the present disclosure to its fullest extent. All publications recited herein are hereby incorporated by reference in their entirety.

It should be emphasized that the embodiments of the present disclosure, particularly, any “preferred” embodiments, are merely possible examples of the implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure, and the present disclosure and protected by the following claims.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include ±1%, ±2%, ±3%, ±4%, ±5%, ±6%, ±7%, ±8%, ±9%, or ±10%, or more of the numerical value(s) being modified.

### EXAMPLES

### Example 1

### Sample Preparation and Biotinylation of Protein

To prepare U251 cell conditioned media, 1×10⁶ cells were seeded in a 100 mm plate with complete media. After two days, complete medium was replaced with low serum medium containing 0.2% bovine serum in the presence or absence of 50 ng/ml of recombinant human TNFα. Supernates and cells were collected separately 48 h later.

Cells were lysed with RIPA buffer (20 mM Tris, pH 7.5, 0.15M NaCl, 0.5% sodium deoxycholate, 1% NP-40, 0.1% sodium dodecyl sulfate). Protein concentrations were determined and used to normalize the amount of conditioned media for the protein arrays. Serum and plasma were collected according to standard protocols. To prepare the cell lysate, cells growing in complete media were harvested immediately upon reaching confluence and lysed in RIPA buffer. Cell lysates were prepared by homogenization. Prior to biotin-labeling, samples were extensively dialyzed against phosphate buffered solution (PBS). The labeling process was carried out according to the manufacturer's instructions (Pierce, Rockford, Ill.).

### Example 2

### Antibody Chip Technology

A RAYBIO HUMAN BIOTIN-LABELED ANTIBODY ARRAY®, glass slide format (AAH-BLG-1, RayBiotech, Inc., Norcross, Ga.) was used and capable of detecting 507 different human proteins, including cytokines, chemokines, growth and differentiation factors, angiogenic factors, adipokines, adhesion molecules, and matrix metalloproteases, as well as binding proteins, inhibitors and soluble receptors to these proteins. Antibodies were selected according to the following criterion: 1) The antibody had been extensive characterized; 2). The antibody recognized a single band in Western blot analysis; 3). Proteins detected by the antibody were secreted or detected in body fluid. Those antibodies (approx. 200 μg/ml) were printed onto Corning slides (Corning Incorporated, Corning, N.Y.) using a noncontact arrayer. A series of diluted anti-streptavidin, and biotin-specific IgG (BIgG) were included in the printed array as positive controls, while capture antibody diluent was used as a negative control.

Procedures were according to the manufacturer's manual for the RAYBIO HUMAN BIOTIN-LABELED ANTIBODY ARRAY® (AAH-BLG-1, RayBiotech, Inc., Norcross, Ga.), incorporated herein by reference in its entirety. Accordingly:

### Sample Biotin-Labeling:

100 μl 1×PBS, pH=8.0 was dispensed into the “Internal Control Tube” and pipetted up and down to dissolve the powder. For labeling, cell culture supernates, 180 μl dialyzed sample were transferred into a new tube and 40 μl of prepared Internal Control was added and mixed. For labeling serum or plasma, 40 μl of the prepared Internal Control was added into a new tube containing 35 μl of dialyzed serum or plasma sample and 155 μl of 0.1M sodium carbonate buffer (pH=8).

100 μl of 1×PBS was into the stock “Labeling Reagent Solution” to prepare 1× Labeling Reagent Solution. An appropriate amount of prepared “Labeling Reagent” was added into above tube with sample prepared as above and incubated at room temperature with gentle shaking for 30 min with gently tapping to mix the reaction solution every 5 min. (For labeling cell culture supernates: 36 μl of 1× “Labeling Reagent Solution” was used for 1 mg total protein in the cell culture supernates. For labeling serum or plasma, 22 μl of “Labeling Reagent Solution” was added to each prepared serum or plasma sample.). 3 μl 10 mM Tris (pH=7.6) buffer was then added into above reaction solution and immediately dialyze as follows.

### Dialysis of Sample:

The cell culture supernates, serum or plasma are dialyzed with a dialysis tube before the biotin-labeling procedure. 200 μl cell culture supernate or 100 μl 5-fold diluted serum/plasma with 1×PBS (pH=8) (20 μl serum or plasma and 80 μl 1×PBS) is loaded into a dialysis tube and dialyzed for at least 3 hr with gentle stirring with at least 500 ml of 1×PBS buffer (pH=8) at 4° C. The 1×PBS buffer was changed and the dialysis period repeated. The sample total volume could be changed after dialysis.

1×PBS (pH=8.0): 0.6 g potassium chloride; 24 g sodium chloride; 0.6 g potassium phosphate; 3.45 g bisodium phosphate dissolve in 2.5 L deionized or distilled water. Adjust pH=8.0 with 1M sodium hydroxide and the final volume adjusted to 3 L with deionized or distilled water. Samples were centrifuged at 10,000 g for 5 min (4° C.) after dialysis.

### Blocking and Incubation of Antibody Array:

Glass chips were brought to room temperature, and air dried for 1 hour in a clean environment before use. 400 μl of kit supplied “Blocking Buffer” was added into each well (Glass Chip with Frame) and incubated at room temperature for 30 min to block slides, while ensuring there were no bubbles in the well.

The “Blocking Buffer” was completely decanted from each well and 400 μl of each sample was into appropriate wells. Arrays were incubated with sample (2-10 fold dilution for biotin-labeled cell culture supernates and 40 fold dilution for serum/plasma) at room temperature for 2 hours with gentle shaking or 4° C. overnight.

The samples were decanted from each well, washed 3 times with 800 μl of 1× kit supplied “Wash Buffer I” at room temperature with gentle shaking for 5 min per wash. The glass chip with frame was put into a box with 1× “Wash Buffer I” (covering the whole glass slide and frame with “Wash Buffer I”), and washed twice at room temperature with gentle shaking for 10 min per wash.

The Wash Buffer I was decant from each well, and the glass chip with frame was put into the box with kit supplied “Wash Buffer II” (covering the whole glass slide and frame with the “Wash Buffer II”), and wash twice at room temperature with gentle shaking for 5 min. All of the “Wash Buffer II” was removed from the well and 400 μl of 1× fluorescent dye-conjugated streptavidin (cy3 equivalent) (prepared as follows: the kit supplied “Fluorescent dye-Conjugated Streptavidin” was briefly spin down before use and 1000 μl of “Blocking Buffer” was added into the tube to prepare a Streptavidin Concentrate and mixed gently. 200 μl of Streptavidin Concentrate was added into a tube with 800 μl of “Blocking Buffer” and mixed gently to prepare 1× Streptavidin solution before adding to each subarray). The incubation chamber was covered with an adhesive film and aluminum foil to avoid exposure to light, or incubated in a dark room. The arrays were incubated at room temperature for 2 hours with gentle shaking.

The solution was decanted and the slide disassembled out of the incubation frame and chamber. The glass chip was then put into a 30 ml centrifuge tube containing with 30 ml of 1× “Wash Buffer I” (to cover the whole slide) and gently shaken for 10 min. The wash buffer was replaced and the wash repeated twice more. The glass chip was then washed twice with 30 ml of 1× “Wash Buffer II” for 5 min per wash. Finally, the glass chip was washed with 30 ml of deionized or distilled water for 5 min.

### Fluorescence Detection:

The glass chip was put into a 50 ml centrifuge tube and dried by centrifuge at 1,000 rpm for 3 min, by a compressed N₂ stream, or by air-drying in a clean environment (protect from light). Make sure the slides are absolutely dry before the scanning procedure. The signals could be visualized with a laser scanner, such as the Axon GenePix, using the cy3 channel.

### Example 3

### Enzyme-Linked Immunoassay (ELISA)

Conventional ELISA for a particular analyte was performed according to the RAYBIO ELISA® manual for that analyte (RayBiotech, Inc., Norcross, Ga., USA). Essentially, pre-coated 96 well ELISA plates for different captured antibodies were first blocked using a blocking buffer. Patients' sera were diluted to final volumes of 100 μl. Aliquots (100 μl per well) of diluted sera and the various concentrations of standard protein were loaded onto the ELISA plate in duplicate. The plates were incubated for 2 hrs at room temperature. Unbound materials were washed out and the appropriate biotinylated anti-cytokine detection antibody was added to each well. The plates were incubated for 1 hr at room temperature.

After washing, 100 μl of streptavidin-HRP-conjugated antibodies were added to the wells and incubation was continued for 30 min at room temperature. After extensive washing, color development was performed by incubation with substrate solution according to the RAYBIO ELISA® manual. After adding stop solution, the optical density (O.D.) at 450 nm was determined for each well by a microplate reader. Standard curves were generated by SigmaPlot v10.0 (Systat Software, San Diego, Calif.) and the concentrations of the samples were determined by comparison to the standard concentration curves.

### Example 4

### Patients Populations

Serum samples from 47 patients diagnosed with early-stage (I and II) and late-stage (III and IV) ovarian cancer, 33 patients with benign tumor and 39 healthy controls were tested, as shown in Table 2. Information about ovarian cancer diagnosis, staging, histology, grade and age was available, date of birth was not provided. All serum samples were aliquoted and stored at −80° C. until use.

### Example 5

### Data Analysis

The array data of ovarian cancer patients and normal subjects were normalized based on the positive control signal, consisting of biotin-labeled antibodies, printed on each array, compared to a common reference array. After subtraction of local background signals, the fluorescent signal intensity for each spot was multiplied by a normalization factor, calculated as the average signal intensity of the positive control spots on the reference array divided by the average signal intensity of the positive control spots located on the same array as the data being normalized.

Positive control normalization compensated for differences in the relative fluorescent signal responses to standardized amounts of biotin-labeled proteins bound on each array. Subsequently, a background threshold value was determined as the mean signal intensity ±2 SD of 10 control samples where the slide arrays were assayed without patient's serum samples. The background threshold value was then subtracted from the signal intensities for each spot. After background subtraction, negative signal intensities were assigned a value of 1. Where signal intensities for a particular analyte were less than the background threshold in all samples tested, those cytokines were removed from further analysis.

### Example 6

### Statistical Analysis

ANOVA statistical methods were used to test the significance of the protein expression differences between ovarian cancer patients and healthy controls by using SPSS software. For inclusion in further classification studies, the cut off for statistical significance for each analyte was P<0.05.

### Example 7

### Classification Analysis

The classification tree method was used to discriminate between ovarian cancer and normal controls by first searching the range of each potential cytokine marker and finding the split that maximized the homogeneity of the two data classes. Within each resulting subset, the algorithm again searched the range of each variable to choose the optimal split. This process continued until all observations are perfectly discriminated, or the sample size within a given subset is too small to divide further.

### Example 8

### Split-Point Score Analysis

The split point divides the sample space into two intervals, one for ovarian cancer and one for normal controls. The best split score of each marker was chosen to ensure the minimization of misclassified samples. A score of 0 is assigned to a sample if it falls in the normal control interval; a score of 1 is assigned to a sample if it falls in the ovarian cancer interval.

Overall, an individual was assigned a score as the sum of these assigned scores from N different markers. Therefore, the range of such score was between 0 to N. A given threshold T was chosen to 10 optimally separate ovarian cancer from healthy controls; i.e., a given individual with a total score of <T is predicted to have normal status, whereas an individual with a total score of >T was diagnosed as ovarian cancer.

Receiver Operating Characteristics Curve (ROC) and Assay Performance Characteristics ROC curves were plotted by sensitivity (true positive) against 1-specificity (false positive) values. According to ROC, the following parameters were calculated to assess assay performance of discriminating ovarian cancer from normal controls. (1) Specificity (true negative); (2) Sensitivity (true positive) (3) positive predicted value (PPV); (4) negative predicted value (NPY); (5) accuracy (both true positive and true negative).

### Example 9

### Performance of Biotin-Labeled-Based Antibody Arrays

The overall sensitivity of the RAYBIO HUMAN LABEL-BASED ARRAYS®, detecting 507 human proteins, was tested. A pool of purified recombinant proteins were labeled with biotin. A series of dilutions (to final concentrations of 1000, 100, 10, and 0 pg/ml) of biotinylated proteins were applied to the antibody chips. The signals were then detected using streptavidin-conjugated fluorescent dye and a fluorescence laser scanner. The data were collected, and the minimal detection sensitivity were calculated as the signals larger then 2 SE+background.

As shown in the Table 1, most of proteins can be detected at pg/ml levels.

TABLE 1
Detection Sensitivity of Biotin Label-based Antibody Arrays

| | | Array |
|---|---|---|
| | | Sensitivity |
| | Target Proteins | (pg/ml) |
| 1 | Activin A | 10 |
| 2 | Adiponectin/Acrp30 | 20 |
| 3 | AgRP | 10 |
| 4 | ALCAM | 20 |
| 5 | Angiogenin | 20 |
| 6 | AR (Amphiregulin) | 20 |
| 7 | Axl | 10 |
| 8 | B7-1/CD80 | 10 |
| 9 | BCMA/TNFRSF17 | 10 |
| 10 | BDNF | 10 |
| 11 | β-NGF | 50 |
| 12 | BLC/BCA-1/CXCL13 | 100 |
| 13 | BMP-5 | 100 |
| 14 | BTC | 10 |
| 15 | Cardiotrophin-1/CT-1 | 10 |
| 16 | CTLA-4/CD152 | 30 |
| 17 | CXCL16 | 50 |
| 18 | Dtk | 15 |
| 19 | EGF | 10 |
| 20 | EGF R/ErbB1 | 15 |
| 21 | Endoglin/CD105 | 20 |
| 22 | Eotaxin/CCL11 | 10 |
| 23 | Eotaxin-2/MPIF-2 | 20 |
| 24 | Eotaxin-3/CCL26 | 10 |
| 25 | ErbB3 | 10 |
| 26 | Fas/TNFRSF6 | 30 |
| 27 | Fas Ligand | 10 |
| 28 | FGF Basic | 10 |
| 29 | FGF-4 | 1000 |
| 30 | FGF-6 | 100 |
| 31 | FGF-7/KGF | 8 |
| 32 | FGF-9 | 8 |
| 33 | Follistatin | 60 |
| 34 | GITR/TNFRF18 | 20 |
| 35 | HB-EGF | 5 |
| 36 | HCC-4/CCL16 | 8 |
| 37 | HGF | 20 |
| 38 | I-309 | 30 |
| 39 | IGFBP-1 | 20 |
| 40 | IGFBP-2 | 10 |
| 41 | IGFBP-3 | 10 |
| 42 | IGF-I | 20 |
| 43 | IGF-I | 1000 |
| 44 | IGF-I SR | 10 |
| 45 | IGF-II | 30 |
| 46 | IGF-II | 1000 |
| 47 | IL-1 alpha | >1000 |
| 48 | IL-1 beta | 10 |
| 49 | IL-1 R4/ST2 | 20 |
| 50 | IL-1 sRI | 20 |
| 51 | IL-1 sRI | 20 |
| 52 | IL-10 | 10 |
| 53 | IL-10 R β | 8 |
| 54 | IL-13 R α1 | 20 |
| 55 | IL-13 R α2 | 1000 |
| 56 | IL-17 | 20 |
| 57 | IL-18 BPa | 10 |
| 58 | IL-18 R alpha/IL-1 R5 | 20 |
| 59 | IL-18 R beta/AcPL | 15 |
| 60 | IL-2 R alpha | 20 |
| 61 | IL-2R alpha | 200 |
| 62 | IL-3 | 30 |
| 63 | IL-4 | 50 |
| 64 | I-TAC/CXCL11 | 10 |
| 65 | Leptin (OB) | >1000 |
| 66 | LIF | 100 |
| 67 | LIGHT/TNFSF14 | 80 |
| 68 | LIGHT/TNFSF14 | 100 |
| 69 | MCP-2 | 100 |
| 70 | MCP-3 | 10 |
| 71 | MCP-4/CCL13 | 10 |
| 72 | M-CSF | 10 |
| 73 | MMP-10 | 10 |
| 74 | MMP-13 | 50 |
| 75 | MMP-9 | 30 |
| 76 | MSP α-chain | 10 |
| 77 | MSP β-chain | 100 |
| 78 | NAP-2 | 100 |
| 79 | NGF R | 20 |
| 80 | NT-4 | 10 |
| 81 | OSM | 15 |
| 82 | Osteoprotegerin | 50 |
| 83 | PDGF R beta | 15 |
| 84 | PDGF-AA | 10 |
| 85 | PDGF-AB | 200 |
| 86 | PDGF-BB | 5 |
| 87 | PIGF | 10 |
| 88 | P-selectin | 10 |
| 89 | RAGE | 10 |
| 90 | RANTES | 20 |
| 91 | SCF | 10 |
| 92 | SCF R/CD117 | 10 |
| 93 | sgp130 | 30 |
| 94 | Siglec-9 | 20 |
| 95 | Siglec-5/CD170 | 40 |
| 96 | Tarc | 300 |
| 97 | TGF-alpha | 10 |
| 98 | TNF RI/TNFRSF1A | 10 |
| 99 | TNF RII/TNFRSF1B | 30 |
| 100 | TNF-β | >1000 |
| 101 | TRAIL R1/DR4/TNFRSF 10/ | >1000 |
| 102 | TRAIL R3/TNFRSF 10C | 10 |
| 103 | TRAIL R4/TNFRSF 10D | 10 |
| 104 | TRANCE | 1000 |
| 105 | TREM-1 | 10 |
| 106 | TROP/TNFRSF19 | 10 |
| 107 | uPAR | 1000 |
| 108 | VCAM-1 (CD106) | 10 |
| 109 | VE-Cadherin | 10 |
| 110 | VEGF | 10 |
| 111 | VEGF R2 (KDR) | 10 |
| 112 | VEGF R3 | 10 |

Purified antigens were diluted into 1×PBS at 1000 ng/ml. After biotin-labeling, biotinylated antigens were diluted with blocking buffer and incubated with array slide. Signals were detected by fluorescence conjugated streptavidin.

The detection dynamics ranged from 5 pg/ml to 1000 pg/ml. The minimal amount of proteins detected was 5 pg/ml. The detection sensitivity for individual proteins varied and depended mainly on the binding affinity for each antigen-antibody interaction, as well as the binding characteristics of the specific antibody to the solid support. However, a linear increase in spot intensity was observed for all proteins tested.

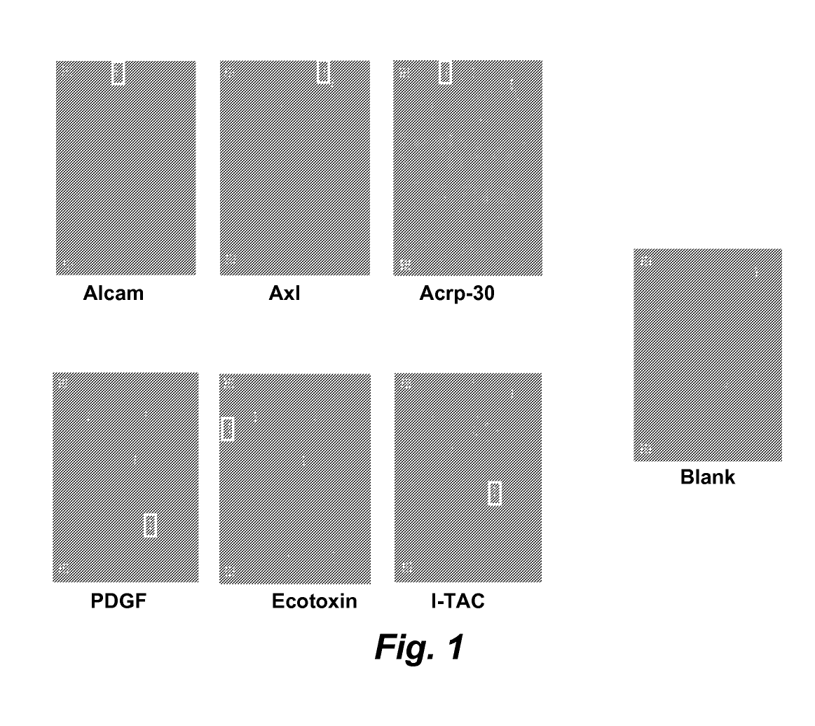

To test the specificity of the arrays, twelve recombinant proteins were individually labeled. Labeled proteins were then incubated with the arrays at a final concentration of 100 ng/ml. As shown in FIG. 1, for example, individual biotin-labeled protein mainly bound to the spot where its corresponding antibody was printed even at high concentrations, indicating high specificity of the arrays. No signal was detected when biotin-labeled solvent was used, demonstrating the specificity of the system.

### Example 10

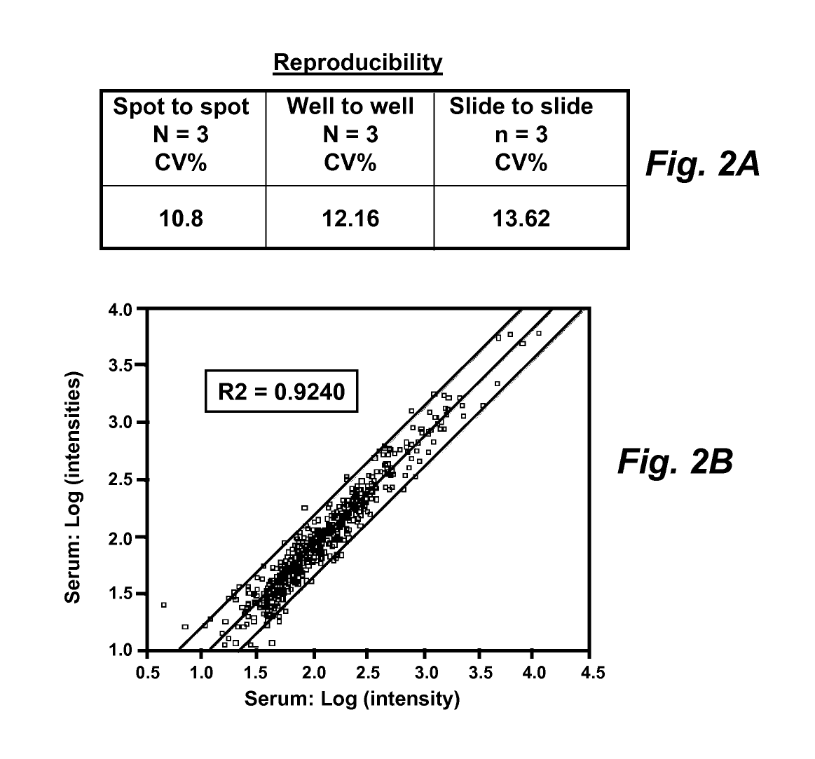

The variability was determined by comparing the signals from 3 different spots replicated in the same chip (spot to spot), from three distinct subarrays printed on the same chip (well to well) or from three different arrays on three separate chips (slide to slide), as shown in FIGS. 2A and 2B. The coefficient of variation (CV; defined as the standard deviation divided by the average) was generally less than 20%. Reproducibility was also examined by scatter plot analysis in the arrays using same serum samples in two different experiments, as shown in FIG. 2B.

### Example 11

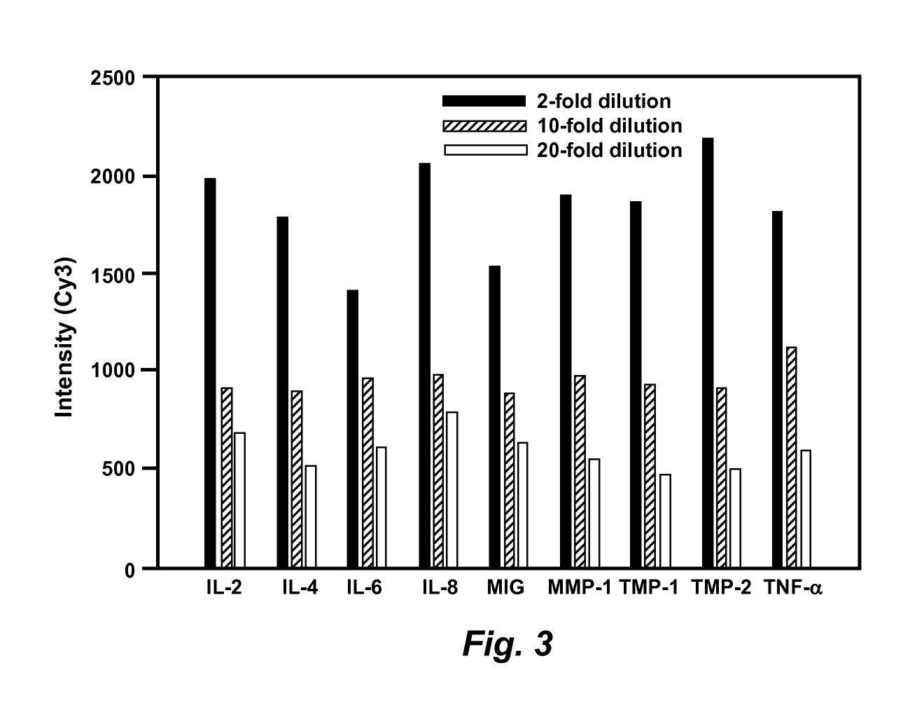

To test the detection linearity, conditioned medium samples were diluted 2-fold, 10-fold, and 20-fold. The diluted samples were labeled with biotin and subjected to the antibody array assay. As shown in FIG. 3, linearity was observed for all analytes tested.

One of advantages of using a biotin-based approach is that the signals can be detected by a variety of systems, including ECL and DAB staining, two of the most common methods of detecting proteins. To demonstrate the feasibility of detection systems, several biological samples were labeled with biotin and subjected to an array assay. The specific signals could be detected by ECL and DAB staining. Therefore, multiple detection systems can be used to detect biotin-labeled proteins in this approach.

### Example 12

### Validation of Biotin-Labeled-Based Antibody Arrays

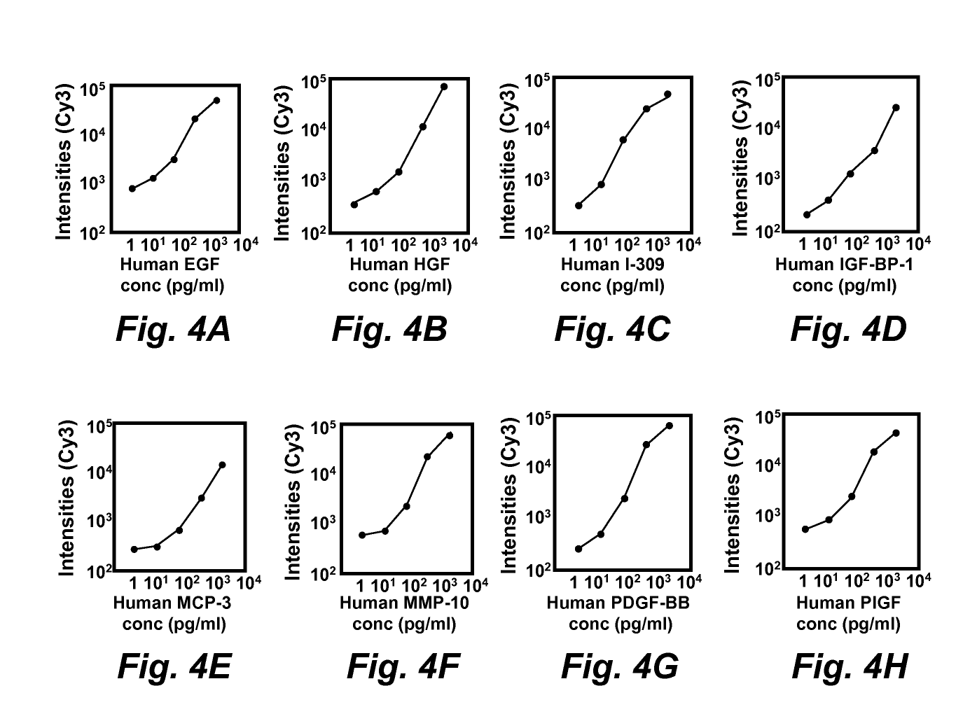

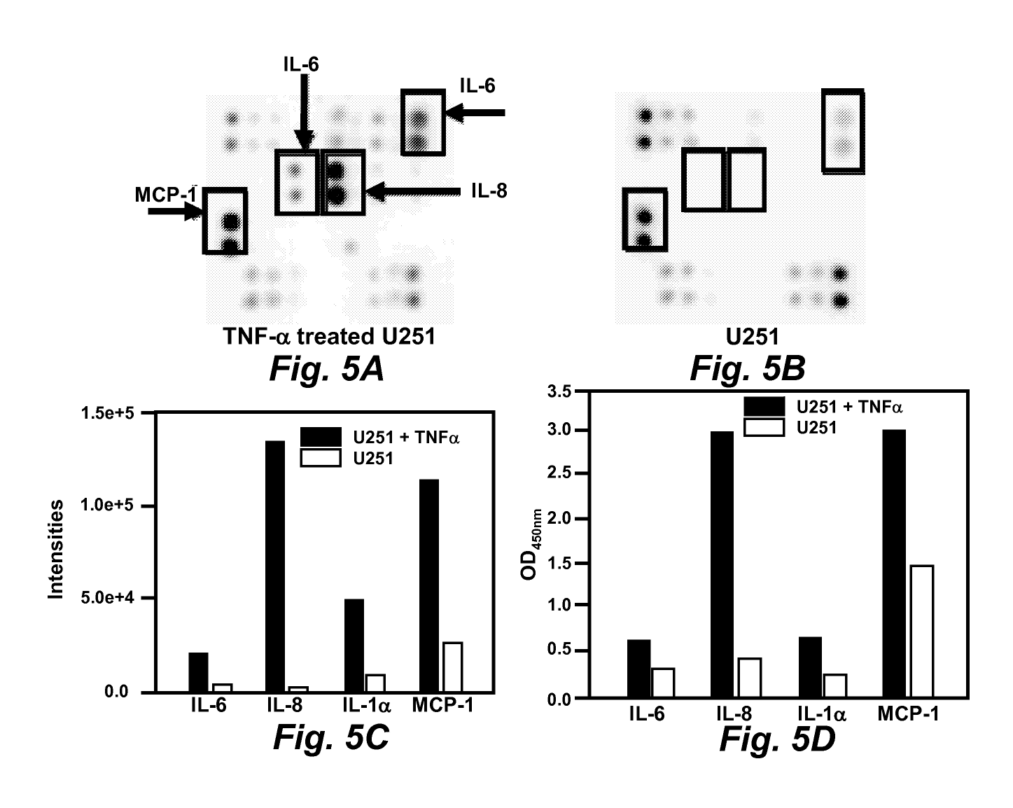

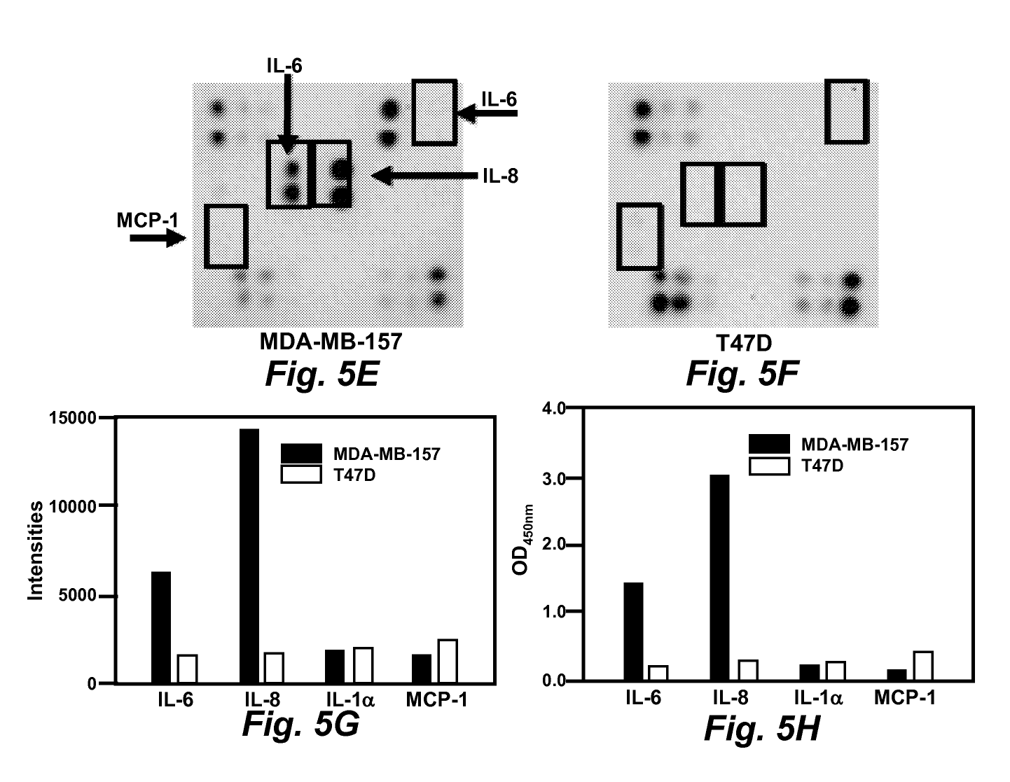

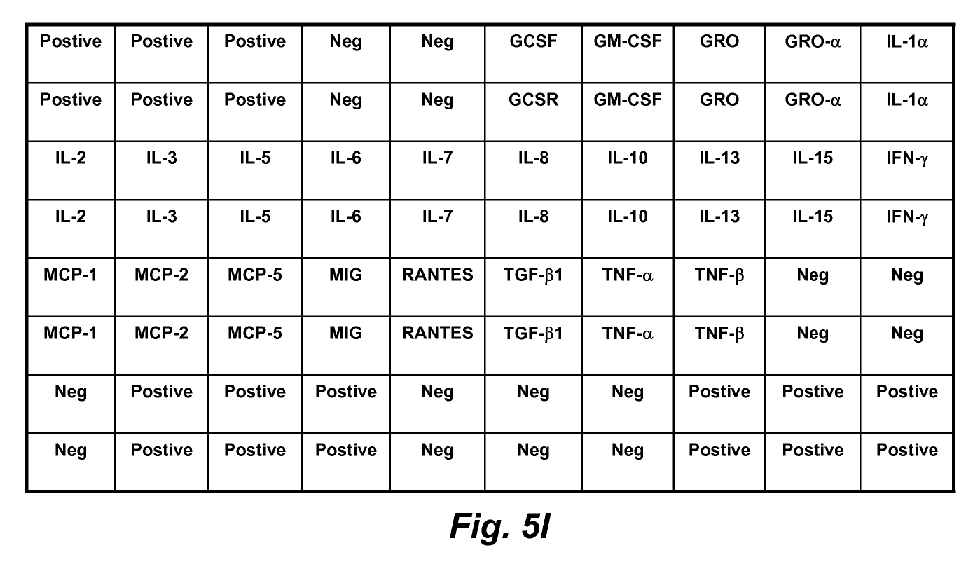

Spike-in experiments were conducted to ensure that the arrays could detect the corresponding protein. As shown in FIGS. 4A-4H, individual proteins were spiked into the 13 serum sample, labeled with biotin and probed with human 507 arrays. Typically, a linear response could be observed with the proteins tested. The data obtained from the arrays were validated using conventional ELISA. It has been shown that TNFα can induce IL-6 expression in human glioblastoma cells U251 (Huang at al., (2001) Anal. Biochem. 294: 55-62). Accordingly, the conditioned media from U251 cells treated with or without TNFα were assayed using biotin label-based antibody arrays according to the present disclosure. Several proteins, such as IL-1α, IL-6, and IL-8 were strongly induced by TNFα, as shown in FIGS. 5A and 5B. The data were further validated using ELISA, as shown in the FIGS. 5C and 5D. The expression pattern was similar between the two data sets, with the ELISA data confirming the relative changes in protein expression seen in the semi-quantitative arrays. Similar results were obtained using TNFα-treated human breast cancer cells.

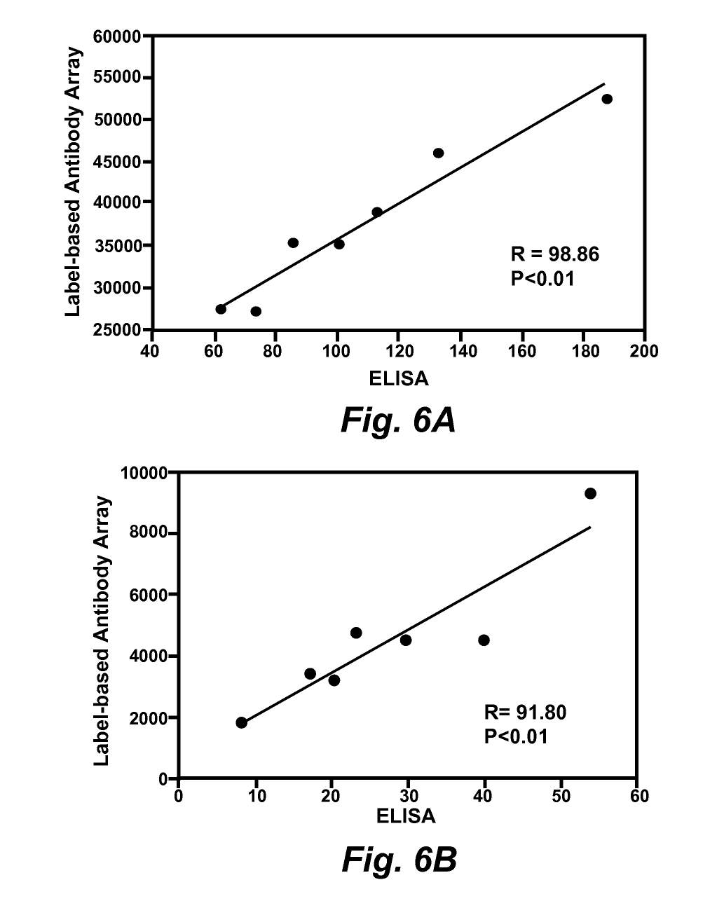

These results were further validated using human serum samples, as shown in FIGS. 6A and 6B. BDNF and ACRP-30 were measured by both biotin label-based antibody arrays and ELISA from 7 human serum samples. There was linear correlation between array and ELISA data sets.

The biotin-labeled array system of the present disclosure has be shown to be capable of detecting proteins in other biological samples besides serum, plasma and cell-cultured media, including tears, saliva, urine and cerebrospinal fluid, cell lysates, tissue lysates, sputum, wound fluid, follicular fluid, saliva and many others. Useful results were obtained using these diverse sample sources with at least one of glass slide arrays (fluorescence detection), membrane (chemiluminescence detection) formats, or both.

Unlike results using sandwich ELISA-based arrays where samples from monkeys (Souquiere et al., (2009) J. Med. Primatol. 38: 279-289), pigs (Hausman et al., (2006) J. Anim. Sci. 84: 1666-1681), rabbits (He et al., (2004) Stroke 35: 2378-2384), and chinchillas (Hong et al., (2007) Infect. Immun. 75: 958-965) show little or no cross-species reactivity with other species, including murine or bovine samples, the human biotin label-based antibody arrays according to the present disclosure have demonstrable cross-species reactivity with samples from varied species, including those of canine, feline, ovine and rodent origin, demonstrating repeatable protein expression patterns.

### Example 13

### Ovarian Cancer Biomarker Discovery Using Biotin Label-Based Antibody Arrays

The expression levels of 507 protein markers in serum samples from 47 patients with ovarian cancers, 33 patients with benign ovarian masses, and 39 healthy, age-matched controls were determined using the RAYBIO HUMAN BIOTIN LABEL-BASED ANTIBODY ARRAY®, as shown in Table 2.

TABLE 2
Sample Information

| | Normal | Benign | Cancer |
|---|---|---|---|
| Total Samples | 39 | 33 | 47 |
| Age (Mean) | 44.64 | 48.09 | 46.70 |
| Age (Median) | 45 | 51 | 48 |
| Age (Range) | 35-58 | 17-62 | 31-54 |
| Cancer Histology | | | |
| Serous Adenocarcinoma | | | 20 |
| Mucious Adenocarcinoma | | | 5 |
| Endometriod Carcinoma | | | 12 |
| Clear Cell Carcinoma | | | 10 |
| Cancer Stage | | | |
| Stage I | | | 8 |
| Stage II | | | 1 |
| Stage III and IV | | | 34 |
| NA | | | 4 |

The mean age of 3 groups are as follows, 43.78 yrs for those with ovarian cancers, 47.27 yrs for those with benign ovarian masses and 47.28 yrs for healthy normal controls, with no statistically significant among the 3 groups (P>0.05). Of the 59 samples from patients with ovarian cancer, 30 were serous adenocarcinoma, 6 were mucous adenocarcinoma, 13 were endomeriod type, and 10 were clear cell carcinoma. By staging of the ovarian cancers, 12 samples were Stage I and II, 43 were Stage II and IV, and 4 were not determined (Table 2).

Protein levels larger than background +2×SD were subjected to ANOVA tests. 84 proteins were differentially expressed between healthy women and those with ovarian cancers with P values of less than 0.05.

To differentiate between ovarian cancers and normal healthy controls after sample decoding, statistical cluster analysis was performed. The classification tree analysis method discriminated between patients with ovarian cancer and normal controls by first searching the range of each potential cytokine marker and finding the split that maximized the homogeneity of the two populations. Within each resulting subset, the algorithm again searched the range of each variable to choose the optimal split. This process continued until all observations were perfectly discriminated, or the sample size was within a given subset too small to divide further.

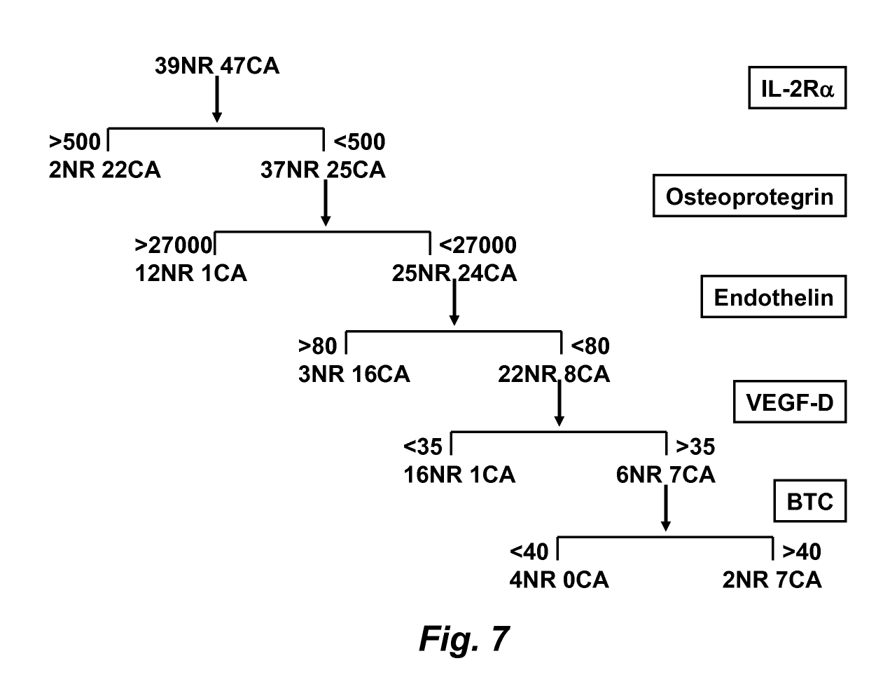

As schematically shown in FIG. 7, the model used all observations in both normal and cancer groups to fit the model. Five markers were selected from the protein panels with significant differential expression between healthy women and those with ovarian cancers (P<0.05), including IL-2 receptor α, endothelin, osteprotegerin, VEGF-D and BTC. Overall, about 90% of the subjects were correctly classified. To develop a rapid assessment method for further testing, data from both ovarian cancers and normal healthy controls was used to develop split scores for each of the 5 markers plus osteoactivin (or HGFIN).

The split point divided the sample space into two intervals, one for patients with ovarian cancer and one for normal controls. The best split score of each marker was chosen to ensure the minimization of misclassified samples. A score of 0 was assigned to a sample if it fell in the normal control interval; a score of 1 was assigned to a sample if it fell in the cancer interval. Overall, an individual was assigned a score as the sum of these assigned scores from N different markers. Therefore, the range of such score was between 0 and 6.

Table 3 gives the split-point signal level criterion for each marker.

TABLE 3
Markers with Significant Difference (P < 0.05 and SE >
BK + 2SD) Using Label-based Antibody Arrays

| | Health | | Benign | | Ovarian | | |
|---|---|---|---|---|---|---|---|
| Marker | Mean | S | Mean | S | Mean | S | P |
| 6Ckine | 237.7 | 40.9 | 140.2 | 26.2 | 218.6 | 39.1 | 0.048 |
| Angiopoietin- | 81.9 | 14.3 | 217.2 | 45.9 | 115.3 | 36.7 | 0.009 |
| BDNF | 29385.7 | 3126.8 | 21399.8 | 2423.2 | 10574.2 | 1353.2 | 0.049 |
| BMP- | 4558.9 | 1117.4 | 1954.6 | 367.4 | 679.6 | 90.0 | 0.032 |
| BT | 48.6 | 12.0 | 167.3 | 54.6 | 70.8 | 23.3 | 0.049 |
| Cardiotrophin-1/CT- | 48.2 | 18.8 | 106.2 | 20.2 | 17.7 | 4.8 | 0.042 |
| CCR | 341.3 | 116.7 | 66.3 | 20.1 | 17.8 | 4.6 | 0.025 |
| CCR | 1201.5 | 250.1 | 500.5 | 84.5 | 372.5 | 87.4 | 0.011 |
| Chem | 3209.6 | 758.0 | 1171.1 | 267.8 | 208.1 | 43.1 | 0.015 |
| CL | 65.2 | 8.9 | 543.4 | 189.7 | 84.6 | 22.7 | 0.021 |
| CXCR2/IL-8 | 49519.1 | 3254.1 | 39350.1 | 3607.8 | 32408.4 | 2909.2 | 0.042 |
| DA | 38.1 | 7.0 | 117.5 | 25.6 | 172.2 | 80.1 | 0.006 |
| EDG- | 2327.2 | 337.2 | 1488.5 | 219.8 | 1031.4 | 159.9 | 0.042 |
| Endotheli | 53.2 | 4.9 | 159.0 | 24.4 | 127.8 | 26.5 | 0.000 |
| Eotaxin-3/ | 13.4 | 3.3 | 117.3 | 38.0 | 17.3 | 9.5 | 0.013 |
| ErbB | 22.2 | 4.1 | 99.4 | 23.2 | 34.0 | 7.1 | 0.003 |
| FGF | 3538.7 | 665.3 | 1934.5 | 362.4 | 693.2 | 107.1 | 0.040 |
| FGF | 16959.7 | 3590.9 | 8506.7 | 1937.3 | 2803.2 | 1121.4 | 0.044 |
| FGF-10/KGF- | 65.1 | 6.9 | 133.5 | 22.1 | 92.0 | 12.4 | 0.006 |
| FGF- | 5309.5 | 853.7 | 2804.6 | 488.2 | 1401.3 | 270.3 | 0.014 |
| FGF- | 33.9 | 6.0 | 129.3 | 24.3 | 46.0 | 9.0 | 0.000 |
| GDF | 30.4 | 5.9 | 69.4 | 11.3 | 41.0 | 5.3 | 0.004 |
| GDF- | 4432.7 | 656.2 | 1910.3 | 327.6 | 1800.5 | 494.7 | 0.001 |
| GFR alpha- | 149.7 | 27.9 | 277.0 | 45.8 | 119.9 | 21.3 | 0.023 |
| GITR Ligand/ | 92.4 | 18.5 | 242.1 | 51.9 | 84.9 | 13.1 | 0.011 |
| Glypican | 11965.1 | 1542.9 | 7078.1 | 978.5 | 7066.4 | 879.4 | 0.010 |
| Granzyme | 435.7 | 62.5 | 274.9 | 30.0 | 338.0 | 82.6 | 0.022 |
| ICAM- | 116.7 | 19.4 | 212.9 | 36.9 | 80.1 | 9.0 | 0.029 |
| IFN-α/IFN-β | 161.4 | 34.7 | 386.2 | 64.6 | 123.5 | 18.7 | 0.003 |
| IFN- | 71.2 | 7.3 | 137.5 | 19.3 | 102.7 | 26.0 | 0.003 |
| IGFBP- | 117.6 | 19.4 | 377.4 | 120.9 | 97.3 | 13.9 | 0.050 |
| IGFBP- | 10504.0 | 1060.1 | 6856.8 | 938.7 | 6471.0 | 850.4 | 0.013 |
| IGF- | 38.6 | 5.6 | 72.5 | 12.7 | 81.2 | 17.6 | 0.023 |
| IL-1 R6/IL-1 | 81.3 | 16.5 | 144.9 | 22.7 | 70.0 | 9.0 | 0.031 |
| IL-1 | 29305.1 | 2757.9 | 21658.5 | 2420.7 | 16398.5 | 2300.9 | 0.040 |
| IL-13 R α | 398.8 | 58.4 | 1044.6 | 221.3 | 350.0 | 71.5 | 0.008 |
| IL-17B | 3981.7 | 673.5 | 1788.62 | 267.0 | 1377.2 | 189.7 | 0.004 |
| IL- | 6620.0 | 851.3 | 3631.5 | 535.0 | 3039.0 | 435.1 | 0.004 |
| IL- | 35221.4 | 3029.1 | 25044.9 | 3719.1 | 22451.1 | 3818.6 | 0.037 |
| IL-18 | 121.5 | 12.9 | 180.2 | 17.1 | 136.2 | 26.4 | 0.009 |
| IL- | 3499.4 | 551.0 | 1778.1 | 337.7 | 2347.4 | 477.5 | 0.010 |
| IL-2 R | 218.9 | 65.8 | 859.1 | 164.0 | 251.7 | 42.5 | 0.000 |
| IL-2 R | 799.2 | 164.9 | 1519.6 | 263.8 | 370.5 | 61.0 | 0.027 |
| IL-2 R γ | 171.2 | 25.6 | 322.1 | 64.5 | 140.9 | 18.9 | 0.042 |
| IL-20 R | 153.0 | 30.6 | 378.8 | 83.4 | 130.4 | 38.0 | 0.017 |
| IL- | 2244.6 | 488.1 | 1060.4 | 169.9 | 890.5 | 206.9 | 0.027 |
| IL-22 | 266.0 | 42.2 | 153.7 | 22.2 | 96.9 | 21.0 | 0.022 |
| IL- | 149.3 | 20.4 | 246.9 | 29.7 | 115.7 | 18.9 | 0.010 |
| IL-3 R | 103.7 | 18.6 | 237.4 | 39.9 | 55.1 | 10.5 | 0.004 |
| IL- | 328.3 | 40.1 | 775.4 | 125.6 | 309.7 | 128.9 | 0.001 |
| IL-4 | 56380.0 | 2622.1 | 66649.9 | 3717.6 | 57709.3 | 4362.9 | 0.032 |
| IL- | 207.6 | 28.1 | 480.6 | 105.5 | 208.4 | 33.6 | 0.021 |
| IL-9 | 74.3 | 23.2 | 191.1 | 39.2 | 56.7 | 11.8 | 0.015 |
| Kremen- | 1443.6 | 285.7 | 3170.6 | 721.9 | 5595.0 | 1226.1 | 0.038 |
| Lc | 99.2 | 20.9 | 203.7 | 35.0 | 149.4 | 24.3 | 0.016 |
| Leptin | 1260.8 | 195.0 | 580.6 | 61.7 | 1297.9 | 373.8 | 0.001 |
| Lipocalin- | 11923.1 | 1841.3 | 6047.1 | 781.5 | 6768.2 | 1479.6 | 0.005 |
| Lymphotoxin beta/ | 2010.6 | 431.3 | 955.5 | 195.9 | 481.3 | 89.3 | 0.031 |
| MIP- | 42593.8 | 3562.6 | 31035.6 | 3634.0 | 26158.4 | 2677.7 | 0.027 |
| MMP- | 2107.3 | 410.6 | 998.2 | 205.5 | 485.3 | 73.6 | 0.020 |
| MMP- | 425.2 | 62.7 | 640.7 | 81.4 | 235.7 | 26.6 | 0.044 |
| MMP- | 43.9 | 12.2 | 152.0 | 46.2 | 41.9 | 8.5 | 0.036 |
| MMP- | 1214.0 | 248.0 | 632.3 | 119.7 | 567.2 | 81.3 | 0.041 |
| MSP β- | 2490.8 | 710.8 | 933.9 | 213.4 | 959.8 | 238.7 | 0.042 |
| Neuritin | 1524.5 | 220.5 | 949.0 | 125.9 | 1168.5 | 165.9 | 0.028 |
| Neuropilin- | 29.3 | 4.3 | 154.3 | 45.9 | 49.6 | 11.4 | 0.013 |
| Neurturin | 2128.4 | 397.4 | 1031.0 | 198.9 | 1397.5 | 285.5 | 0.017 |
| NRG | 54.0 | 16.8 | 189.5 | 41.2 | 133.5 | 39.1 | 0.004 |
| Orexin | 54.9 | 13.7 | 280.0 | 104.8 | 60.3 | 17.2 | 0.049 |
| Osteoactivin/ | 12845.7 | 1630.5 | 7077.4 | 1141.6 | 8519.2 | 1588.7 | 0.005 |
| Osteoprotegerin/ | 22163.9 | 3374.5 | 10674.6 | 1765.9 | 10954.8 | 2076.4 | 0.004 |
| Pref- | 26.1 | 4.8 | 116.3 | 22.2 | 36.7 | 5.6 | 0.000 |
| Prolactin | 37.9 | 11.3 | 86.5 | 19.4 | 43.7 | 12.8 | 0.041 |
| SIGIR | 13455.5 | 2238.3 | 40335.2 | 8401.7 | 11353.5 | 3634.1 | 0.004 |
| TGF-β RI/ALK- | 73.7 | 10.3 | 108.8 | 11.2 | 71.0 | 10.3 | 0.027 |
| Thrombospondin- | 55.1 | 13.0 | 99.1 | 17.8 | 99.8 | 45.8 | 0.045 |
| TIMP- | 67.8 | 11.0 | 147.1 | 35.6 | 73.8 | 15.6 | 0.048 |
| TSG- | 21.9 | 3.5 | 103.0 | 22.3 | 33.0 | 4.7 | 0.001 |
| VE- | 27.0 | 7.5 | 259.9 | 87.2 | 25.5 | 3.9 | 0.015 |
| VEGF | 134.6 | 17.6 | 204.3 | 24.3 | 153.0 | 28.5 | 0.025 |
| VEGF- | 41.2 | 7.3 | 79.0 | 10.1 | 37.4 | 4.2 | 0.004 |
| WIF- | 49.4 | 9.7 | 112.2 | 23.2 | 44.3 | 7.0 | 0.019 |

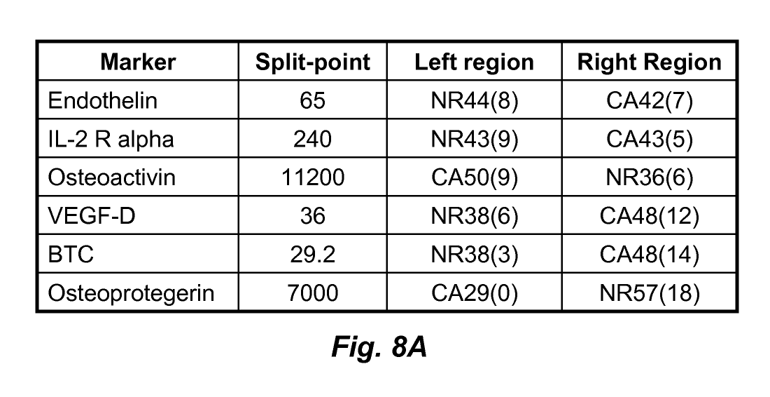

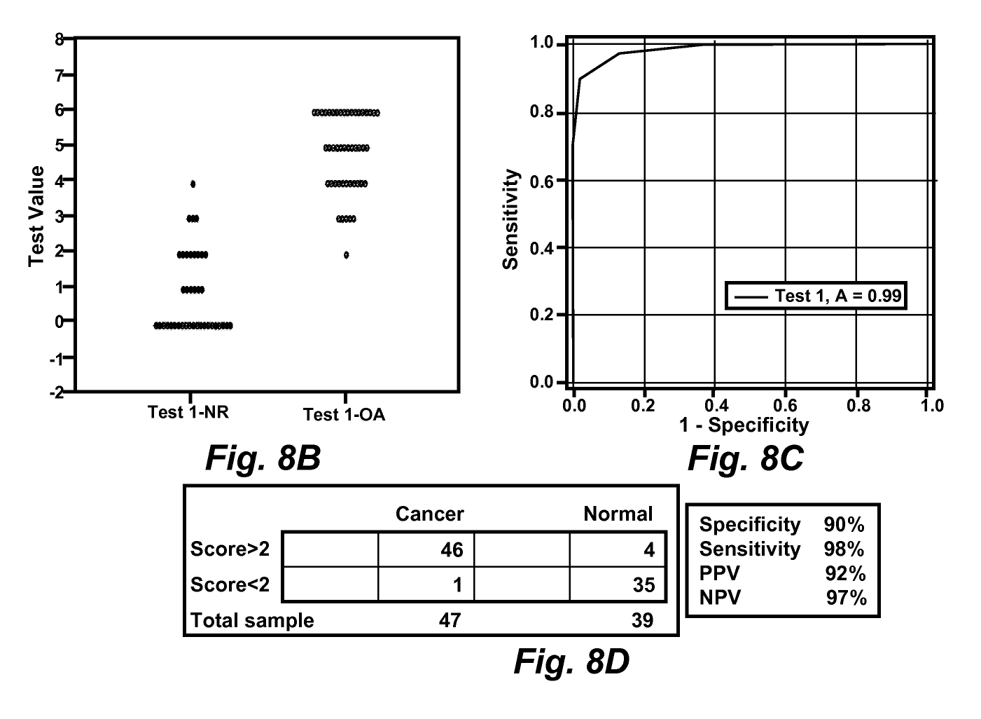

Individual marker classifications using split-point score method were inadequate to discriminate ovarian cancers from normal control. However, by using split-point score analysis of 6 markers in which cancer was predicted to have a score of three or more markers with a score of 1, 98% of ovarian cancers (46 of 47) were correctly diagnosed. In the healthy control group, 90% were correctly identified (35 of 39). The overall accuracy rate for both cancer and normal healthy controls were 94% (81 of 87), as shown in FIG. 8D.

A Receiver Operating Characteristics curve (ROC) was plotted using a 6-marker panel obtained from split-point score analysis, with sensitivity (true positive) as y-axis and 1-specificity (false positives) as the x-axis. According to ROC, the overall performance of 39 normal healthy 16 controls and 47 cancer samples were: Sensitivity 98%, specificity 90%, NPV 97% and PPV 92%. Area under the curve (AUC) was 99%. Accordingly, the 6-marker panel demonstrated an enhanced performance of combination of 6 protein markers for prediction of ovarian cancers compared to single-biomarker discrimination, as shown in FIG. 8C.

### Example 14

A panel of 11-protein markers was also developed to distinguish benign ovarian tumors from ovarian cancers using split-point score analysis. These 11 markers are: CXCR2/IL-8 RB, Frizzled-1, IFN-α, IL-2 Rα, IL2 Rβ/CD122, IL-3, IL-3 Rα, IL-4, IL-1 R6/IL-1 Rrp2, IL-18 BPa, and VEGF-D. Individual marker classifications using split-point score method were inadequate to discriminate ovarian cancers from benign ovarian tumors. However, by using split-point score analysis of 11 markers in which cancer is predicted to have a score of six or more markers with a score of 1, 89% of ovarian cancers (41 of 46) were correctly diagnosed. In the benign ovarian tumor group, 85% were correctly identified (28 of 33). The overall accuracy rate for both cancer and normal healthy controls was about 87% (69 of 79). The ROC curve was also plotted using 11-marker panel obtained from split-point score analysis. According to ROC, Area Under the Curve (AUC) was 90%.

What is claimed:

1. A system for identifying at least one biomarker characteristic of a cancer or a cancer cell, the system comprising:
(a) an antibody array comprising at least one antibody species capable of capturing a biomarker characteristic of a cancer or a cancer cell;
(b) a system for biotinylating at least one biomarker of a biosample obtained from a subject human or animal; and
(c) a detectable biotin-binding polypeptide.

2. The system according to claim 1, further comprising a system to detect the biotin-binding polypeptide.

3. The system according to claim 1, further comprising a system for solubilizing the at least one biomarker of a biosample obtained from a subject human or animal.

4. The system according to claim 3, wherein the system for solubilizing the at least one biomarker of a biosample obtained from a subject human or animal comprises a system for lysing cells of the biosample.

5. The system according to claim 1, wherein the biomarker, or a plurality of said biomarkers, is selected from the group consisting of: activin A; IL-18 BPa, adiponectin/acrp30, IL-18 receptor α/IL-1 R5, AgRP, IL-18 receptor 13/AcPL, ALCAM, IL-2 receptor α, angiogenin, IL-2 receptor α, AR (amphiregulin), IL-3, Axl, IL-4, B7-1/CD80, I-TAC/CXCL11, BCMA/TNFRSF17, leptin (OB), BDNF, LIF, β-NGF, LIGHT/TNFSF14, BLC/BCA-1/CXCL13, LIGHT/TNFSF14, BMP-5, MCP-2, BTC, MCP-3, cardiotrophin-1/CT-1, MCP-4/CCL13, CTLA-4/CD152, M-CSF, CXCL16, MMP-10, Dtk, MMP-13, EGF, MMP-9, EGF receptor/ErbB1, MSP α-chain, endoglin/CD105, MSP β-chain, Eotaxin/CCL11, NAP-2, eotaxin-2/MPIF-2, NGF R, eotaxin-3/CCL26, NT-4, ErbB3, OSM, Fas/TNFRSF6, osteoprotegerin, Fas Ligand, PDGF receptor β, FGF Basic, PDGF-AA, FGF-4, PDGF-AB, FGF-6, PDGF-BB, FGF-7/KGF, PIGF, FGF-9, P-selectin, follistatin, RAGE, GITR/TNFRF18, RANTES, HB-EGF, SCF, HCC-4/CCL16, SCF receptor/CD117, HGF, sgp130, I-309, Siglec-9, IGFBP-1, siglec-5/CD170, IGFBP-2, Tarc, IGFBP-3, TGFα, IGF-I, TNF RI/TNFRSF1A, IGF-I, TNF RII/TNFRSF1B, IGF-I S receptor, TNFβ, IGF-II, TRAIL R1/DR4/TNFRSF 10/, IGF-II, TRAIL R3/TNFRSF 10C, IL-1α, TRAIL R4/TNFRSF 10D, IL-1β, TRANCE, IL-1 R4/ST2, TREM-1, IL-1 sRI, TROP/TNFRSF19, IL-1 sRI, uPAR, IL-10, VCAM-1 (CD106), IL-10 receptor β, VE-cadherin, IL-13 receptor α1, VEGF, IL-13 receptor α2, VEGF R2 (KDR), IL-17, VEGF R3, or any combination thereof.

6. The system according to claim 1, wherein the antibody array comprises a plurality of antibody species capable of specifically capturing at least one biomarker characteristic of a cancer or a cell thereof, wherein the cancer is selected from the group consisting of: bladder cancer, breast cancer, colorectal cancer, endometrial cancer, head and neck cancer, leukemia, lung cancer, lymphoma, melanoma, non-small-cell lung cancer, ovarian cancer, prostate cancer, testicular cancer, uterine cancer, cervical cancer, thyroid cancer, gastric cancer, brain stem glioma, cerebellar astrocytoma, cerebral astrocytoma, glioblastoma, ependymoma, Ewing's sarcoma family of tumors, germ cell tumor, extracranial cancer, Hodgkin's disease, leukemia, acute lymphoblastic leukemia, acute myeloid leukemia, liver cancer, medulloblastoma, neuroblastoma, brain tumors generally, non-Hodgkin's lymphoma, osteosarcoma, malignant fibrous histiocytoma of bone, retinoblastoma, rhabdomyosarcoma, soft tissue sarcomas generally, supratentorial primitive neuroectodermal and pineal tumors, visual pathway and hypothalamic glioma, Wilms' tumor, acute lymphocytic leukemia, adult acute myeloid leukemia, adult non-Hodgkin's lymphoma, chronic lymphocytic leukemia, chronic myeloid leukemia, esophageal cancer, hairy cell leukemia, kidney cancer, multiple myeloma, oral cancer, pancreatic cancer, primary central nervous system lymphoma, skin cancer, and small-cell lung cancer.

7. The system according to claim 6, wherein the antibody array comprises a plurality of antibody species capable of specifically capturing at least one biomarker characteristic of an ovarian cancer.

8. The system according to claim 1, wherein the biotin-binding polypeptide is avidin or streptavidin, or a biotin-binding variant thereof, and wherein the biotin-binding polypeptide is conjugated to a detectable labeling moiety.

9. The system according to claim 8, wherein the detectable labeling moiety is a dye, a fluorescent moiety, or an enzyme.

10. The system according to claim 1, wherein the enzyme is a horse radish peroxidase.

11. The system according to claim 1, wherein the detectable labeling moiety is a dye.

12. A method of detecting at least one biomarker characteristic of a cancer or a cancer cell, the method comprising:
(a) obtaining a first biosample from a first subject human or animal;
(b) biotinylating at least constituent of the first biosample;
(c) contacting the biotinylated first biosample to a first antibody array, said first antibody array comprising at least one antibody species capable of capturing a biomarker characteristic of a cancer or a cancer cell, under conditions whereby a biomarker can selectively bind to an antibody of the first antibody array;
(d) contacting the first antibody array with a detectable biotin-binding polypeptide under conditions whereby the detectable biotin-binding polypeptide can selectively bind to a biotin moiety conjugated to a biomarker of the first biosample, wherein said biomarker is selectively bound to an antibody of the antibody array; and
(e) detecting the detectable biotin-binding polypeptide bound to a biotin moiety conjugated to a biomarker of the biosample, wherein said biomarker is selectively bound to an antibody of the first antibody array.

13. The method according to claim 12, wherein the first biosample is obtained from a subject human or animal having a cancer, and further comprising the steps of:
(f) obtaining a second biosample from a second subject human or animal not having a cancer;
(g) contacting the second biosample with a system for biotinylating a constituent of the second biosample;
(h) contacting the biotinylated second biosample to a second antibody array, wherein the first and the second antibody arrays are identical, and under conditions whereby a biomarker can selectively bind to an antibody of the second antibody array;
(i) contacting the second antibody array with a detectable biotin-binding polypeptide under conditions whereby the detectable biotin-binding polypeptide can selectively bind to a biotin moiety conjugated to a constituent of the second biosample, wherein said constituent is a biomarker selectively bound to an antibody of the second antibody array;
(j) detecting the detectable biotin-binding polypeptide bound to a biotin moiety conjugated to a constituent of the second biosample, wherein said constituent is a biomarker selectively bound to an antibody of the second antibody array; and
(k) comparing the results of steps (e) and (j), whereupon a detectable signal on the first antibody array but not on the second antibody array indicates the identity of a biomarker characteristic of the cancer of the first subject human or animal.

14. The method according to claim 12, wherein the detectable biotin-binding polypeptide is an avidin, a streptavidin, or a biotin-binding variant thereof, and wherein the detectable biotin-binding polypeptide is conjugated to a detectable labeling moiety.

15. The method according to claim 13, wherein the detectable biotin-binding polypeptide is an avidin, a streptavidin, or a biotin-binding variant thereof, and wherein the detectable biotin-binding polypeptide is conjugated to a detectable labeling moiety.

16. The method according to claim 12, wherein the biomarker, or a plurality of said biomarkers, is selected from the group consisting of: activin A; IL-18 BPa, adiponectin/acrp30, IL-18 receptor α/IL-1 R5, AgRP, IL-18 receptor β/AcPL, ALCAM, IL-2 receptor α, angiogenin, IL-2 receptor α, AR (amphiregulin), IL-3, Axl, IL-4, B7-1/CD80, I-TAC/CXCL11, BCMA/TNFRSF17, leptin (OB), BDNF, LIF, β-NGF, LIGHT/TNFSF14, BLC/BCA-1/CXCL13, LIGHT/TNFSF14, BMP-5, MCP-2, BTC, MCP-3, cardiotrophin-1/CT-1, MCP-4/CCL13, CTLA-4/CD152, M-CSF, CXCL16, MMP-10, Dtk, MMP-13, EGF, MMP-9, EGF receptor/ErbB1, MSP α-chain, endoglin/CD105, MSP β-chain, Eotaxin/CCL11, NAP-2, eotaxin-2/MPIF-2, NGF R, eotaxin-3/CCL26, NT-4, ErbB3, OSM, Fas/TNFRSF6, osteoprotegerin, Fas Ligand, PDGF receptor β, FGF Basic, PDGF-AA, FGF-4, PDGF-AB, FGF-6, PDGF-BB, FGF-7/KGF, PIGF, FGF-9, P-selectin, follistatin, RAGE, GITR/TNFRF18, RANTES, HB-EGF, SCF, HCC-4/CCL16, SCF receptor/CD117, HGF, sgp130, I-309, Siglec-9, IGFBP-1, siglec-5/CD170, IGFBP-2, Tarc, IGFBP-3, TGFα, IGF-I, TNF RI/TNFRSF1A, IGF-I, TNF R11/TNFRSF1B, IGF-I S receptor, TNFβ, IGF-II, TRAIL R1/DR4/TNFRSF 10/, IGF-II, TRAIL R3/TNFRSF 10C, IL-1α, TRAIL R4/TNFRSF 10D, IL-1β, TRANCE, IL-1 R4/ST2, TREM-1, IL-1 sRI, TROP/TNFRSF19, IL-1 sRI, uPAR, IL-10, VCAM-1 (CD106), IL-10 receptor β, VE-cadherin, IL-13 receptor α1, VEGF, IL-13 receptor α2, VEGF R2 (KDR), IL-17, VEGF R3, or any combination thereof.

17. The method according to claim 12, wherein the antibody array comprises a plurality of antibody species capable of specifically capturing at least one biomarker characteristic of a cancer or a cell thereof, wherein the cancer is selected from the group consisting of: bladder cancer, breast cancer, colorectal cancer, endometrial cancer, head and neck cancer, leukemia, lung cancer, lymphoma, melanoma, non-small-cell lung cancer, ovarian cancer, prostate cancer, testicular cancer, uterine cancer, cervical cancer, thyroid cancer, gastric cancer, brain stem glioma, cerebellar astrocytoma, cerebral astrocytoma, glioblastoma, ependymoma, Ewing's sarcoma family of tumors, germ cell tumor, extracranial cancer, Hodgkin's disease, leukemia, acute lymphoblastic leukemia, acute myeloid leukemia, liver cancer, medulloblastoma, neuroblastoma, brain tumors generally, non-Hodgkin's lymphoma, osteosarcoma, malignant fibrous histiocytoma of bone, retinoblastoma, rhabdomyosarcoma, soft tissue sarcomas generally, supratentorial primitive neuroectodermal and pineal tumors, visual pathway and hypothalamic glioma, Wilms' tumor, acute lymphocytic leukemia, adult acute myeloid leukemia, adult non-Hodgkin's lymphoma, chronic lymphocytic leukemia, chronic myeloid leukemia, esophageal cancer, hairy cell leukemia, kidney cancer, multiple myeloma, oral cancer, pancreatic cancer, primary central nervous system lymphoma, skin cancer, and small-cell lung cancer correlating the results from step (e) with the specificity of the antibody selectively binding the biotinylated constituent of the biosample, thereby detecting at least one biomarker.

18. The method according to claim 12, wherein the first biosample is a biofluid, a cell suspension, a cell culture medium, or a cell lysate.

19. The method according to claim 13, wherein the second biosample is a biofluid, a cell suspension, a cell culture medium, or a cell lysate.

20. The method according to claim 12, wherein the antibody array comprises a plurality of antibody species capable of specifically capturing at least one biomarker characteristic of an ovarian cancer.
